(19) United States
(12) Patent Application Publication
(10) Pub. No.: US 2016/0012536 A1
(43) Pub. Date: Jan. 14, 2016

(54) METHODS AND SYSTEMS FOR ADDRESSING CONVEXITY IN AUTOMATED VALUATION OF FINANCIAL CONTRACTS

(71) Applicant: FinancialCAD Corporation, Surrey (CA)

(72) Inventors: Russell GOYDER, Coquitlam (CA); Mark John GIBBS, Mill Bay (CA)

(21) Appl. No.: 14/793,395

(22) Filed: Jul. 7, 2015

Related U.S. Application Data
(60) Provisional application No. 62/022,634, filed on Jul. 9, 2014.

(51) Int. Cl. G06Q 40/06; G06Q 10/06

(52) U.S. Cl. CPC G06Q 40/06; G06Q 10/067

(57) ABSTRACT

Methods and systems for addressing convexity in automated valuation of financial contracts comprising payment functions are provided. The absence of convexity in a payment function may be detected and, where an absence of convexity is determined, the payment function based on an intrinsic value of the payment function may be valuated. Attempting to detect the absence of convexity may involve modifying the payment function by extracting a numeraire-transform factor and correspondingly changing a numeraire associated with an expectation of the payment function. Valuating the payment function based on an intrinsic value of the payment function may involve multiplying the intrinsic value of the modified payment function by one or more time-zero factors. If a lack of convexity is not detected, the payment function may be valuated based on replication, which may involve modifying the payment function by injecting a numeraire-transform factor.

### REFERENCE TO RELATED APPLICATIONS

This application claims priority from U.S. provisional application No. 62/022,634 filed 9 Jul. 2014. All of the applications and patents referred to in this paragraph are hereby incorporated herein by reference.

### TECHNICAL FIELD

This technology relates to automated valuation of financial contracts. Particular embodiments provide methods and systems for addressing convexity in automated valuation of financial contracts.

### BACKGROUND

Modern financial contracts, involving financial derivatives and/or the like (for example), are complex. There is a desire to model these complex financial contracts and, in particular, valuate these financial contracts. It is known to simulate financial contracts using Monte-Carlo simulation techniques. While general in their approach, Monte-Carlo simulations are computationally expensive and may be relatively complex to setup, typically requiring considerable time and energy of one or more quantitative analysts.

There is a general desire for systems and methods which minimize, or at least reduce, the computational expense and/or complexity of modeling financial contracts while still providing reasonably accurate results.

The foregoing examples of the related art and limitations related thereto are intended to be illustrative and not exclusive. Other limitations of the related art will become apparent to those of skill in the art upon a reading of the specification and a study of the drawings.

### SUMMARY

The following embodiments and aspects thereof are described and illustrated in conjunction with systems, tools and methods which are meant to be exemplary and illustrative, not limiting in scope. In various embodiments, one or more of the above-described problems have been reduced or eliminated, while other embodiments are directed to other improvements.

Aspects of this disclosure provide methods and systems for addressing convexity in automated valuation of financial contracts comprising payment functions. Particular aspects provide systems and methods which comprise attempting, by a computer or processor, to detect the absence of convexity in a payment function and, where an absence of convexity is determined, valuating, by the computer or processor, the payment function based on an intrinsic value of the payment function. Attempting to detect the absence of convexity may comprise attempting to detect the absence of convexity symbolically, by the computer or processor, using a symbolic algebra routine. Attempting to detect the absence of convexity may comprise modifying, by the computer or processor, the payment function by extracting a numeraire-transform factor and correspondingly changing, by the computer or processor, a numeraire associated with an expectation of the payment function. Such modification of the payment function may expose a lack of convexity that was previously undetectable by the symbolic algebra routine. Where such modification of the payment function occurs and results in a detection of an absence of convexity, valuating the payment function based on an intrinsic value of the payment function may comprise multiplying, by the computer or processor, the intrinsic value of the modified payment function by one or more time-zero factors. If a lack of convexity is not detected or convexity is detected, then the methods and systems may comprise valuating, by the computer or processor, the payment function based on replication. Valuating the payment function based on replication may comprise modifying, by the computer or processor, the payment function by injecting a numeraire-transform factor and correspondingly changing, by the computer or processor, a measure associated with an expectation of the payment function. Systems and methods may also comprise numerically detecting, by the computer or processor an absence of convexity in the payment function.

Aspects of this disclosure provide systems and methods for addressing convexity in automated valuation of financial contracts. The methods are performed by a processor and the systems comprise a processor configured to perform the steps of the methods. The methods involve receiving, by the processor, an input payment function and setting, by the processor, a current payment function based on the input payment function. The current payment function is associated with a current measure. The methods involve determining, by the processor, a non-convexity status based on the current payment function. The non-convexity status comprises at least one of: a confirmation indication corresponding to a confirmation of non-convexity and a failure indication corresponding to a failure to confirm non-convexity of the input payment function. The method comprises determining, by the processor, an output valuation based on an intrinsic value if the non-convexity status comprises a confirmation indication. The intrinsic value is based on the current payment function and the current measure. The method comprises determining, by the processor, that the intrinsic value is not suitable as a valuation for the input payment function if the non-convexity status comprises a failure indication.

In some embodiments, determining a non-convexity status comprises checking for an absence of convexity based on the current payment function. Checking for an absence of convexity comprises: determining, by the processor, whether the current payment function comprises one or more stochastic variables. Checking for an absence of convexity further comprises determining, by the processor, that the non-convexity status comprises a confirmation of non-convexity if the current payment function comprises no stochastic variables. Checking for an absence of convexity further comprises determining, by the processor, whether the one or more stochastic variables satisfy one or more linearity criteria (e.g. respectively) if the current payment function comprises one or more stochastic variables. Checking for an absence of convexity further comprises determining that the non-convexity status comprises a confirmation of non-convexity if the one or more stochastic variables satisfy the one or more linearity criteria (e.g. respectively).

In some embodiments, the method comprises transforming, by the processor, the current payment function based on a numeraire-transform factor and changing, by the processor, the current measure based on a measure associated with the numeraire-transform factor if checking for an absence of convexity does not result in determining that the non-convexity status comprises a confirmation of non-convexity.

In some embodiments, the method comprises iteratively transforming the current payment function based on each of a plurality of numeraire-transform factors until no numeraire-transform factor is detectable in the current payment function.

In some embodiments, the method comprises determining, by the processor, whether a unique natural measure exists for all of the one or more stochastic variables associated with the current payment function and, if the unique natural measure does exist, changing, by the processor, the current measure associated with the current payment function to match the unique natural measure. In some embodiments, changing the current measure to match the unique natural measure comprises: determining, by the processor, whether the current measure matches the unique natural measure and, if the current measure does not match the unique natural measure, determining, by the processor, an injection numeraire-transform factor, which, would, if injected into the current payment function, change the current measure to match the unique natural measure and transforming, by the processor, the current payment function by injecting the injection numeraire-transform factor into the current payment function, thereby changing, by the processor, the current measure to match the unique natural measure.

In some embodiments, transforming the current payment function comprises: determining, by the processor, whether the numeraire-transform factor is present in the current payment function and eliminating, by the processor, the numeraire-transform factor from the current payment function and changing the current measure associated with the current payment function based on the elimination of the numeraire-transform factor if the numeraire-transform factor is determined to be present in the current payment function.

In some embodiments, determining whether the replication measure associated with the replication model may be applied against the plurality of stochastic variables comprises: generating, by the processor, a linear segment representation of the current payment function and determining, by the processor, whether only one linear segment is present in the linear segment representation. The method comprises determining, by the processor, that the non-convexity status comprises a confirmation indication if only one linear segment is present in the linear segment representation. The method comprises performing, by the processor, a replication procedure based on the replication model and determining, by the processor, the output valuation based on the replication procedure if a plurality of linear segments are present in the linear segment representation.

In cases where processors implementing the disclosed methods and systems are able to detect an absence of convexity and/or valuate the payment function by replication, further valuation by numerical techniques, such as Monte Carlo simulation, may not be necessary. Processors may thus avoid more computationally expensive forms of valuation, thereby enabling more efficient valuation of payment functions. This improvement to the efficiency of the processor when valuating payment functions is an improvement to the functioning of the processor itself. Further, as is described in greater detail below, aspects of the disclosed systems and methods may involve transforming payment functions based on numeraire-transform factors and/or other data to create potentially-non-convex payment functions for valuation. Such systems and methods require a fundamental change to the payment functions.

In addition to the exemplary aspects and embodiments described above, further aspects and embodiments will become apparent by reference to the drawings and by study of the following detailed descriptions.

### BRIEF DESCRIPTION OF THE DRAWINGS

Exemplary embodiments are illustrated in referenced figures of the drawings. It is intended that the embodiments and figures disclosed herein are to be considered illustrative rather than restrictive.

FIG. 1 is a schematic illustration of a method for valuating a financial contract according to a particular embodiment.

FIG. 2 is a schematic depiction of a tree representation of a European option which is exemplary of the tree representations of payment functions which may be used in the method of FIG. 1 in some embodiments.

FIG. 3A is a schematic diagram of a method for performing measure analysis which may be used to implement a portion of the method of FIG. 1 in some embodiments. FIG. 3B is a schematic depiction of a method for attempting to determine whether a payment function has an absence of convexity and for valuating the payment function based on the intrinsic value of the payment function if it can be determined that the payment function has an absence of convexity which may be used in connection with the method of FIG. 3A, in some embodiments. FIG. 3C is a schematic depiction of a method for attempting to determine whether there are one or more modeling assumptions available that can be used as a basis for re-writing a payment function in terms of different variables, which may be used in connection with the methods of FIG. 3A and of FIG. 4, in some embodiments.

FIG. 4 is a schematic depiction of a method for changing the measure of the expectation of a payment function to a different measure, which may be used to implement a portion of the method of FIG. 1 in some embodiments.

FIG. 5 is a schematic depiction of a method for evaluating a payoff function by replication which may be used to implement a portion of the method of FIG. 1 in some embodiments.

FIG. 6 is a schematic depiction of a system which may be used to perform any of the methods described herein according to a particular embodiment.

FIGS. 7A, 7B and 7C are graphs which show the functional form of some of the constituent parts of the payment function described in Example H below.

### DESCRIPTION

Throughout the following description specific details are set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive, sense.

Methods and systems are provided for addressing convexity in automated valuation of financial contracts comprising payment functions. Particular embodiments provide systems and methods which comprise attempting, by a computer or processor, to detect the absence of convexity in a payment function and, where an absence of convexity is determined, valuating, by the computer or processor, the payment function based on an intrinsic value of the payment function. Attempting to detect the absence of convexity may comprise attempting to detect the absence of convexity symbolically, by the computer or processor, using a symbolic algebra routine. Attempting to detect the absence of convexity may comprise modifying, by the computer or processor, the payment function by extracting a numeraire-transform factor and correspondingly changing, by the computer or processor, a numeraire associated with an expectation of the payment function. Such modification of the payment function may expose a lack of convexity that was previously undetectable by the symbolic algebra routine. Where such modification of the payment function occurs and results in a detection of an absence of convexity, valuating the payment function based on an intrinsic value of the payment function may comprise multiplying, by the computer or processor, the intrinsic value of the modified payment function by one or more time-zero factors. If a lack of convexity is not detected or convexity is detected, then the methods and systems may comprise valuating, by the computer or processor, the payment function based on replication. Valuating the payment function based on replication may comprise modifying, by the computer or processor, the payment function by injecting a numeraire-transform factor and correspondingly changing, by the computer or processor, a measure associated with an expectation of the payment function. Systems and methods may also comprise numerically detecting, by the computer or processor an absence of convexity in the payment function.

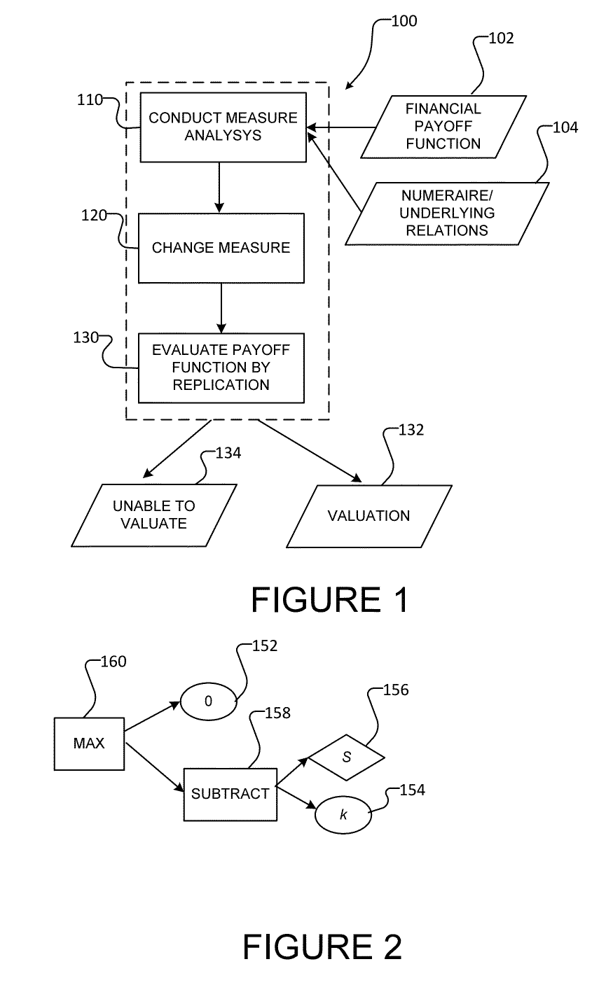

FIG. 1 is a schematic illustration of a method 100 for valuating a financial contract according to a particular embodiment. In general, the types of financial contracts addressed by method 100 involve receiving or making payment(s), where each payment is based on some function of observable quantities. A payment may comprise some of the following characteristics:
(i) Constant overall multipliers, including a notional amount N and an accrual fraction.
(ii) The amount being paid, X(s), which may be a function ƒ of any observable quantities \vec{x}, whose values are known at time s.
(iii) The time of the payment, t≧s.
(iv) The currency B of the payment.

The function ƒ(\vec{x}) may be referred to as the payment function, the payoff function, or in some instances, the term function is dropped, to refer to a payment function as a payment or a payoff. The general desire of method 100 is to valuate the payment function or to determine its expected value (typically an expected present value). The expected present value of a payment function ƒ(\vec{x}) under a measure generated by a numeraire M(t) may be given by

$$V ( 0 ) = N α M ( 0 ) {𝔼}^{M} [ \frac{F ( \vec{x} )}{M ( t )} ] \qquad ( 1 )$$

where the operator [symbol] ^{M} is the expectation operator in the numeraire M(t) and where the superscript M is often omitted. A common, but non-limiting choice of numeraire is a value at time τ of a zero-coupon bond in the payment currency B maturing at the payment time t, which is given by M(τ)=P^{B} (τ, t), where we use M(τ) in the place of M(t) in the numeraire since the variable t is already being used for a different purpose (i.e. the payment time t). In general, the expression P^{B} (τ, t) represents a discount factor in the currency B which provides the factor by which you would multiply a payment in currency B at time t to get the value at time τ. It will be appreciated from this interpretation that P^{B} (t, t)=1—i.e. there is no discount if the payment is received at the same time as the valuation. With the numeraire being the value at time τ of a zero-coupon bond in the payment currency B maturing at the payment time t, which is given by M(τ)=P^{B}(τ, t), equation (1) reduces to:

V(0)=NαP^{B}(0,t) [symbol] ^{B,t}[ƒ(\vec{x})] (2)

where we exploit the fact that the denominator in the equation (1) expectation reduces to unity because P^{B} (t, t)=1.

The payment function ƒ(\vec{x}) may comprise arithmetic operators and some other basic functions. Examples of mathematical functions and basic functions which could be included in a payment function include: PRODUCT, SUM, SUBTRACT, DIVIDE, NEGATION, AVERAGE, POWER, SQUARE ROOT, LOGARITHM, ABSOLUTE VALUE, WEIGHTED SUM, GET INTEGER PART, GET FLOATING POINT PART, FLOOR OF VALUE, ERF (Gaussian error function), ERFC (complementary Gaussian error function), boolean logical operations (e.g. NOT, XOR, MAKE LOGICAL), boolean comparators (e.g. LESS THAN, GREATER THAN, LESS THAN OR EQUAL TO, GREATER THAN OR EQUAL TO, EQUAL TO, NOT EQUAL TO), other functions related to smoothing at discontinuities (e.g. IS LESS WITH SMOOTHING (a boolean function that evaluates a less than condition with smoothing), IS MORE WITH SMOOTHING (a boolean function that evaluates a less than condition with smoothing), SYMMETRIC COMPARISON (a boolean function that evaluates whether its arguments are the same with smoothing), MIN (a function which returns the minimum one of its arguments), MAX (a function which returns the maximum one of its arguments), MIN WITH SMOOTHING, MAX WITH SMOOTHING), and/or the like.

Method 100 receives a payment function ƒ(\vec{x}) as input 102 and attempts to determine whether the input payment function 102 can be valuated intrinsically. In general, given any payment function ƒ of n state variables \vec{x}={x₁, x₂, . . . xₙ}, the intrinsic value of the payment function is given by changing the order of applying expectation and the payment function,

[symbol]

[ƒ(x₁,x₂, . . . ,xₙ)]→ƒ( [symbol] [x₁], [symbol] [x₂], . . . , [symbol] [xₙ]) (9)

The right hand side of equation (9) may be referred to as the intrinsic value of the payment function ƒ. If the payment function ƒ is linear (i.e. lacks convexity), then the expectation of the payment function is given by its intrinsic value. That is:

[symbol]

[ƒ(x₁,x₂, . . . ,xₙ)]=ƒ [symbol] [x₁], [symbol] [x₂], . . . , [symbol] [xₙ]) (9a)

Convexity of the payment function ƒ may be defined to be the difference between the payment function's expected value and its intrinsic value—i.e:

convexity= [symbol] [ƒ(x₁,x₂, . . . ,xₙ)]−ƒ( [symbol] [x₁], [symbol] [x₂], . . . , [symbol] [xₙ]) (9b)

Or, if both the expectation [symbol] and the payment function ƒ are regarded as operators, then convexity may be defined to be their commutator [ [symbol] ,ƒ]= [symbol] ƒ−ƒ [symbol] applied to the state variable vector \vec{x}, i.e. [ [symbol] ,ƒ]\vec{x}.

In general, a payment function can be reliably valuated intrinsically when the payment function lacks convexity. Accordingly, method 100 may comprise attempting to detect convexity and/or to detect a lack of convexity in the input payment function 102 in effort to determine whether a payment function can be valuated intrinsically. Valuating a payment function intrinsically may be relatively computationally inexpensive and may involve relatively little complexity when compared to other valuation techniques, such as Monte Carlo simulation and backward evolution in Fourier space. In some cases, method 100 may not be able to determine that a payment function lacks convexity and/or may be able to determine that a payment function has convexity. In some such cases, the illustrated embodiment of method 100 uses replication techniques for numerically valuating the contract. Replication techniques may be relatively computationally inexpensive and may involve relatively little complexity when compared to other valuation techniques, such as Monte Carlo simulation and backward evolution in Fourier space. In some embodiments, method 100 could be modified to use Monte Carlo simulation, backward evolution in Fourier space and/or other modeling techniques in cases where the method is unable to determine that a payment function lacks convexity and/or the method determines that a payment function has convexity and/or the method is unable to valuate the payment function using replication.

In addition to receiving input payment function 102, method 100 may also receive, as input 104, a set of numeraires and information suitable for comparing numeraires. In some embodiments, method 100 may receive, as input 104, relationships between numeraires and their corresponding measures—i.e. information in respect of the one-to-one relationships between numeraires and their corresponding measures. This is not necessary, however. In some embodiments, these relationships are not required as input 104 as there is a one-to-one relationship between numeraires and measures.

Method 100 of the illustrated embodiment returns one of two outputs. Method 100 may return a valuation 132 of the input payment function 102 (e.g. given by equation (1) for the general case of the present value and equation (2) for the case where the numeraire is the zero coupon bond described above); or method 100 may alternatively return an indication 134 that it is unable to valuate the input payment function 102. As discussed in more detail below, valuation 132 of the input payment function 102 may also comprise an indication of whether valuation 132 was performed intrinsically or using suitable numeric approximation techniques. Indication 134 that method 100 is unable to valuate input payment function 102 may additionally or alternatively comprise a recommendation or invitation to attempt Monte Carlo simulation, backward evolution in Fourier space or some other more complex or computationally expensive modeling technique, commencement of such a technique and/or the like.

Method 100 may comprise analyzing and manipulating payment functions (e.g. input payment function 102) and tracking the measures in which the expected values of payment functions are to be evaluated. Accordingly, there may be a desire for a suitable representation of both payment functions and the numeraires associated with the measures in which the expectations of payment functions are to be evaluated. In addition, method 100 may comprise modifying payment functions (e.g. by modification of numeraire(s)) and so there may be a desire for method 100 to be able to adapt numeraire representation(s) to payment function representation(s) or to otherwise make numeraire representation(s) compatible with payment function representation(s), if such representation(s) are not the same.

A suitable payment function representation may comprise a directed acyclic graph, or tree. The leaves of this tree may comprise constants and/or stochastic variables over which the expected value may be taken to arrive at the expected value of the payment function. These stochastic variables form a set of underlyings for the payment function. Intermediate nodes in the tree may comprise mathematical operators and specific functional forms (see non-limiting examples discussed above). The single root of the tree may hold or represent the final computation. For example, FIG. 2 shows a tree representation 150 of a European option (Example I discussed below), where 0 (at leaf 152) and the strike k (at leaf 154) are constants and the single stochastic variable is the value of the underlying stock at expiry, S (at leaf 156). Representation 150 of the FIG. 2 example also comprises a subtraction operator (at leaf 158) and a max operator (at root 160) to yield max(S−k, 0).

Measures are in one-to-one correspondence with numeraires; consequently, maintaining the latter is sufficient to identify the former and vice versa. A numeraire is itself a positive-valued payment function, and so method 100 may make use of the above-described tree representation to encode numeraires. In this way numeraires can be relatively easily injected into payment functions, as described in more detail below. However, method 100 may comprise evaluating whether two numeraires are equal and recognizing whether a given payment function is (or contains) a numeraire. Comparing two tree representations and/or testing for positivity, by traversing a general set of operator nodes, function nodes and leaf nodes, is relatively computationally expensive and may be difficult to implement. For this reason, when representing numeraires, method 100 may comprise associating a numeraire's tree representation with some form of label indicating the presence of a known type of numeraire, together with some optional attributes. Positivity may then be quickly and easily ascertained by the presence of this label, while comparison of numeraires may be facilitated by comparing labels and, if necessary, attributes. Sample attributes for three common numeraires are given in Table 1. It will be appreciated that any positive function of any one or more numeraire(s) may itself be a numeraire.

TABLE 1
Exemplary common measures, their numeraires and attributes

| Measure | Numeraire Type | Attributes |
|---|---|---|
| Risk- | Bank account exp(∫₀^{τ} r_{B}(s)ds) for | Currency B |
| neutral | short rate r_{B}(t) | |
| t-forward | Zero-coupon bond P^{B}(τ, t) | Maturity time |
| | | t, currency B |
| Annuity | Annuity Aₙ(τ) = Σᵢ₌₁ⁿ αᵢP(τ, tᵢ) | Payment |
| | | schedule |
| | | {αᵢ, tᵢ} for |
| | | i = 1 . . . n |
| FX rate | X_{AB}(τ) value of one unit of currency | Asset |
| | A in currency B at time τ | currency A. |
| | | Numeraire |
| | | currency B. |
| Spot | $\begin{matrix}Discretely compounded bank account \\ {P}^{B} ( τ , {t}_{j} ) {\prod }_{i = 0}^{j - 1} \frac{1}{{P}^{B} ( {t}_{i} , {t}_{i + 1} )} \\ where {t}_{j - 1} < τ \leq {t}_{j} for a set of times \{ {t}_{j} \} , \\ j = 0 , 1 , … n - 1\end{matrix}$ | Currency B. Times {tⱼ}. |

There is also a one-to-one relationship between stochastic variables and their natural measures. The natural measure of a stochastic variable is the measure used to calculate its expected or forward value. Each stochastic variable participating in the FIG. 1 method 100 is associated with, and is able to provide an indication of, its natural measure, suitably encoded. Such relationships between stochastic variables and their natural measures may also be maintained, for example, in a suitable table. Table 2 shows a number of exemplary, non-limiting, stochastic variables and their corresponding natural measures.

TABLE 2
Exemplary stochastic variables and their natural measures

| Variable | Natural Measure |
|---|---|
| Libor rate Lₛₜ^{B} (a) associated with the period that | Currency B, t-forward |
| runs from s to t in currency B at a fixing time a | |
| Forward price of a currency-A denominated | Currency A, t-forward |
| stock S^{A} for time t at time s, Fₜ^{A} (s) | |
| Currency-B worth of one unit of currency A | Currency B, t-forward |
| at time t, X_{AB} (t) | |
| Swap rate in currency B, R^{B} (t) | Annuity Aₙ (t) |

For the purposes of explanation of method 100, we describe the application of method 100 to a number of exemplary and non-limiting example input payment functions 102 which include:
Example A: Constant value: A payment of a constant C at time t.
Example B: Interest rate: A fraction α of an annualized floating rate Lₛₜ(a) (i.e. a rate associated with the period that runs from s to t in currency B at a fixing time a), plus a spread β paid at the rate's natural time t

αLₛₜ(a)+β (87)
Example C: Forward rate agreement: The payment of

$$\frac{{L}_{st} ( a ) - k}{1 + α {L}_{st} ( a )} \qquad ( 88 )$$

at time s.
Example D Libor-In-Arrears: The payment of Lₛₜ(a) at time s.
Example E Asset in foreign economy: The payment of S_{A}(s)X_{AB}(t) in currency B at time t.
Example F Equity quanto: The payment of S_{A}(s) in currency B at time t.
Example G Compounded rate: The payment of

(1+αL₁)(1+αL₂) (89)
at time t₂ where L₁ is the rate starting at t₀ and ending at t₁, and L₂ is the rate starting at t₁ and ending at t₂.
Example H Forward contract via put-call parity: A payment of max(S(s)−k; 0)−max(k−S(s); 0) at time t where t−s encodes the settlement delay implicit in a spot trade of the underlying S(s).
Example I European option: A payment of max(S(s)−k; 0) at time t where t−s encodes the settlement delay implicit in a spot trade of the underlying S(s).

Referring to FIG. 1, method 100 commences in block 110 which comprises conducting measure analysis. The block 110 measure analysis may determine whether a measure exists in which the input payment function 102 may be priced by an available valuation methodology. In the illustrated embodiment of method 100, the available valuation methodologies comprise replication and intrinsic valuation. Replication is discussed in more detail below. In some circumstances, the block 110 measure analysis procedures may detect the absence of convexity, in which case block 110 may directly yield output valuation 132 by intrinsic valuation.

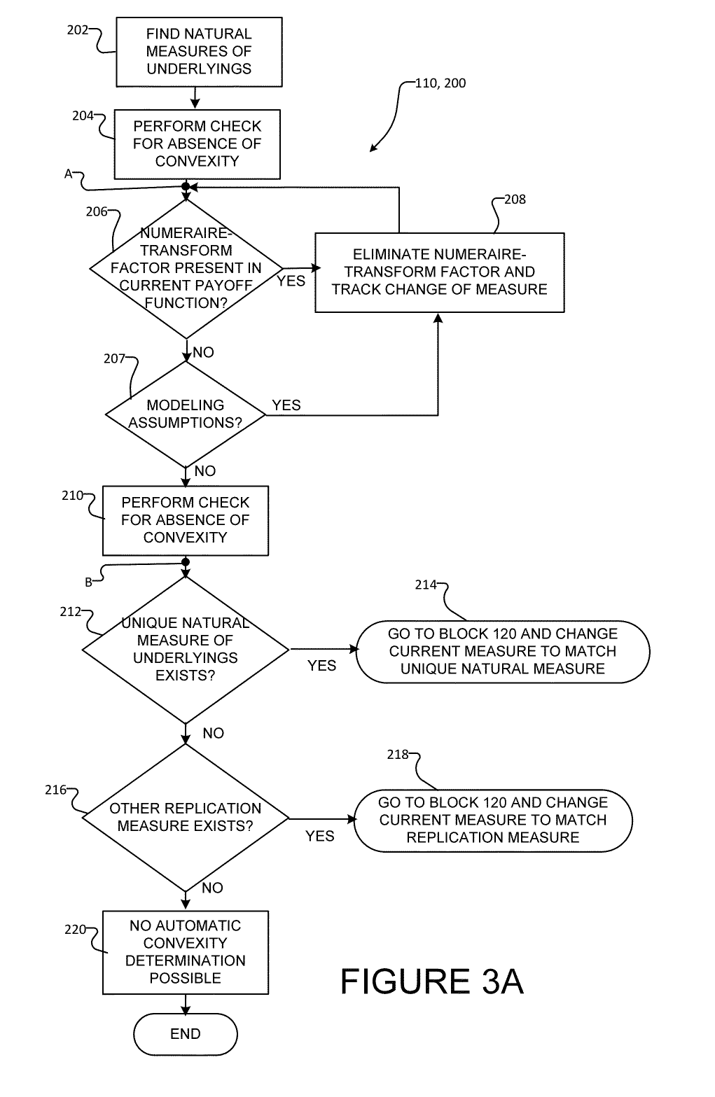

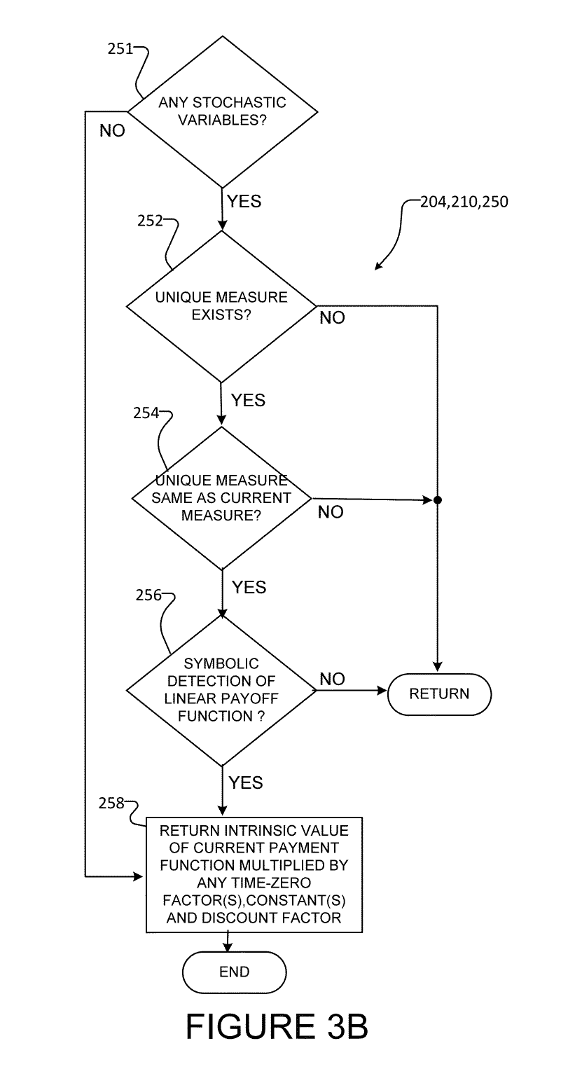

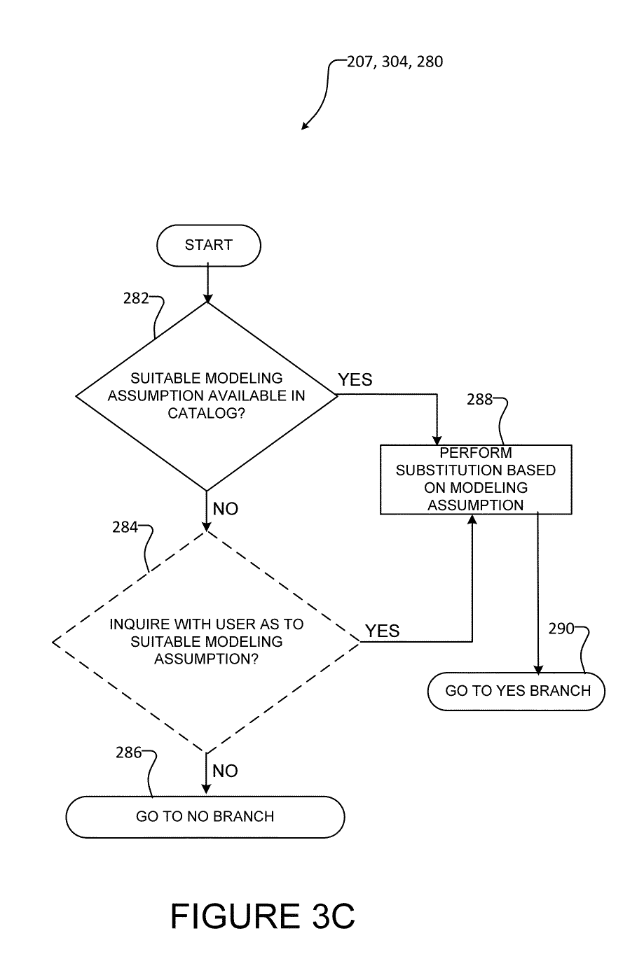

FIG. 3A is a schematic diagram of a method 200 for performing measure analysis according to a particular embodiment. Method 200 of FIG. 3A may be used, in some embodiments, to implement block 110 of the FIG. 1 method 100. Method 200 commences in block 202 which comprises determining the natural measure of each underlying in the input payment function 102. Block 202 may comprise traversing the tree representation of the payment function input 102 to collect the set of stochastic variables upon which the payment function 102 depends. As discussed above, each stochastic variable participating in method 100 is able to provide an indication of its natural measure, suitably encoded.

Method 200 then proceeds to block 204 which comprises performing a check to determine whether the absence of convexity (i.e. the presence of linearity) may be determined (e.g. symbolically) for the input payment function 102. If it can be determined in block 204 that the payment function 102 is linear, then block 204 may also comprise outputting a method 100 valuation 132 (see FIG. 1) based on the intrinsic value of the payment function (multiplied by suitable factors, which may include the constants N, α and discount factor P^{B} (0, t) of equation (2) and which may include one or more time-zero factor(s) described in more detail below).

FIG. 3B is a schematic depiction of a method 250 for attempting to determine whether a payment function has an absence of convexity and, if it can be determined that the payment function has an absence of convexity, for valuating the payment function based on the intrinsic value of the payment function, according to a particular embodiment. In some embodiments, method 250 of FIG. 3B may be used to implement block 204 of method 200 of FIG. 3A. Where an absence of convexity is determined in method 250, the intrinsic value of the payment function determined by method 250 may be used as the basis for the method 100 valuation 132. To arrive at the method 100 valuation 132, the intrinsic value of the payment function determined in method 250 may be multiplied by suitable factors, which may include the constants N, α and discount factor P^{B} (0, t) of equation (2) and which may include one or more time-zero factor(s) described in more detail below. The method 100 valuation 132 may also comprise an indication that the input payment function 102 is linear and/or that valuation 132 is based on an intrinsic value.

In the illustrated embodiment, method 250 begins with the block 251 inquiry as to whether the current payment function includes any stochastic variables. When method 250 is being performed for the first time (e.g. as part of block 204 of method 200 (FIG. 3A)), then the current payment function is the input payment function 102. In some embodiments, however, method 250 may be performed in other circumstances where the current payment function is different than the input payment function 102. Such circumstances are explained in more detail below. If there are no stochastic variables in the current payment function (block 251 NO branch), then method 250 proceeds to block 258. Block 258 is described in more detail below. In most cases, however, the block 251 inquiry will be positive (block 251 YES branch) and method 250 will proceed to block 252.

Block 252 involves an inquiry as to whether the stochastic variables \vec{x} in the current payment function ƒ share a common or unique natural measure. If the block 252 inquiry is negative, then method 250 returns to node A of method 200 (FIG. 3A). If, on the other hand, the block 252 inquiry is positive, then method 250 proceeds to block 254 which comprises another inquiry into whether the unique natural measure of the stochastic variables in the current payoff function matches the measure of the expectation of the current payment function itself (i.e. [symbol] (ƒ(\vec{x})) where ƒ is the current payment function and \vec{x} is the vector which includes the stochastic variables). For brevity, in this description and in any accompanying aspects and/or claims, the measure of the expectation of the current payment function may be referred to as the current measure or, equivalently, the current numeraire. Accordingly, block 254 comprises an inquiry into whether the current measure matches the unique natural measure of the stochastic variables underlying the current payment function.

In some embodiments, the measure of the expectation of the initial payment function input 102 (i.e. the initial current measure) may be set to be the payment-time-forward measure in currency B for a payment in currency B at a particular payment time. Where the payment is at a time t, the payment-time-forward measure may be referred to as the t-forward measure. The choice of the t-forward measure is generated by the numeraire of a zero coupon bond maturing at a time t, M(τ)=P^{B}(τ, t), discussed above in connection with equation (2). In some embodiments, the initial current measure may be selected to be different from the payment-time-forward measure. In some embodiments, method 250 may be performed in other circumstances where the current measure is different than the measure of the expectation of the initial payment function and/or is different than the payment-time-forward measure. Some such circumstances are explained in more detail below.

If the block 254 inquiry is negative (i.e. the current measure does not match the unique natural measure of the stochastic variables underlying the payment function), then method 250 returns to node A of method 200 (FIG. 3A). If, on the other hand, the block 254 inquiry is positive, then method 250 proceeds to block 256 which involves analyzing the current payment function to look for a linear functional form. This block 256 analysis may be performed symbolically using suitable symbolic algebra software routines, such as those provided, for example, by Maple™, Mathematica™, SymPy™ and/or the like. For n variables {xᵢ}, i=1, . . . n, a linear functional form is given by

$$f ( {x}_{0} , {x}_{1} , … , {x}_{n} ) = {\sum }_{i = 1}^{n} {α}_{i} {x}_{i} + {β}_{i} \qquad ( 90 )$$

for constants {αᵢ} and {βᵢ} for i=1, . . . n. If such a form is not detected, then method 250 returns to node A of method 200 (FIG. 3A). If, on the other hand, the block 256 search is positive (i.e. block 256 discerns that the current payment function lacks convexity (is linear)), then method 250 proceeds to block 258 which comprises determining the intrinsic value of the current payment function.

Since the current payment function has been determined to be linear (or non-stochastic) prior to arrival in block 258, the intrinsic value of the current payment function determined in block 258 may be determined in accordance with

$$\begin{matrix}𝔼 [ f ( {x}_{0} , {x}_{1} , … , {x}_{n} ) ] = {\sum }_{i = 1}^{n} {α}_{i} {\overline{x}}_{ι} + {β}_{i} \\ where & ( 91 ) \\ {\overline{x}}_{ι} = 𝔼 [ {x}_{i} ] & ( 92 )\end{matrix}$$

In practice, determining the intrinsic value of the current payment function in block 258 may amount to applying the current payment function to a value obtained by evaluating the forward curve of each underlying stochastic variable at the relevant observation time, without requiring information about the joint probability distribution of the underlying stochastic variables.

As discussed in more detail below, in some embodiments, the current payment function being evaluated in method 200 (and in particular in block 258) is not the same as the input payment function 102. This may be the case, where method 100 involves modifying the payment function and changing the numeraire. In such cases, each modification of the payment function may give rise to a corresponding time-zero factor

$$\frac{M ( 0 )}{{M}^{′} ( 0 )} .$$

Time-zero factors are discussed in more detail in the description of numeraire changes below. Where the payment function valuated in block 258 is not the same as input payment function 102 because of one or more numeraire changes, block 258 may comprise multiplying the intrinsic value of the current payment function by one or more corresponding time-zero factors

$$\frac{M ( 0 )}{{M}^{′} ( 0 )}$$

to obtain the intrinsic value of the input payment function. Additionally, as discussed above, the valuation of input payment function 102 may involve additional factors, which may include the constants N, α and discount factor P^{B}(0, t) of equation (2). Such additional factors may also be multiplied with the intrinsic value of the payment function in block 258 to obtain the final valuation 132 of input function 102.

The valuation determined in block 258 (including the intrinsic value of the current payment function multiplied by any appropriate time-zero factor(s), appropriate constant(s) (e.g. N, α of equation (2)) and an appropriate discount factor (e.g. P^{B}(0, t) of equation (2))) may be output as the method 100 valuation 132 of the input payment function 102 (see FIG. 1). As discussed above, the method 100 valuation 132 may comprise information indicating that the method 100 valuation 132 is the intrinsic value of the input payment function 102 or that the input payment function 102 lacks convexity.

In the set of illustrative examples described above, Example A and Example B both result in proceeding through method 250 (as part of block 204 (FIG. 3A)) to block 258 which involves detection of the absence of convexity and corresponding determination of the intrinsic value of the payment function. The constant C in Example A contains no stochastic variables (block 251 NO branch) and so has no natural measure. The Example A payment function is trivial—the identity—and the block 258 intrinsic value is just C itself. Example B contains one stochastic variable Lₛₜ(a) (block 252 YES branch) whose natural measure is the t-forward measure in the same currency as the payment function. Given that the payment is made at time t, the measure of the payment function is also the t-forward measure (block 254 YES branch), and the payment function matches the linear form of equation (90) (block 256 YES branch). Thus, where the input payment function 102 is the Example B interest rate, the intrinsic value of the payment function is determined in block 258 and method 100 may return (as valuation 132) this intrinsic value multiplied by the constant(s) N, α and discount factor P^{B}(0, t) of equation (2).

In principle, extensive symbolic algebra might be required to detect true linearity in the payment function in this manner (e.g. in block 256). For example, replacing any of the αᵢ with a function of other constants does not introduce convexity, but changes the shape of the payment function tree and therefore changes the requirements for any linearity detection algorithm. Method 250 may ensure that convexity (non-linearity) is detected, but may fail to detect the absence of convexity (linearity). However, other aspects of method 100 (FIG. 1) can detect the absence of convexity hidden in complex calculation trees without the need for sophisticated symbolic algebra. Such steps, however, are based on numerical, not symbolic, methods, and therefore are subject to a numerical tolerance. The convexity detection steps of method 250 amount to an early break-out optimization resulting from detecting the absence of convexity with 100% certainty.

Returning to method 200 (FIG. 3A), if block 204 does not result in the determination of an intrinsic value for payment function 102 (i.e. method 250 returns to node A without reaching block 258), then method 200 proceeds to block 206. Block 206 comprises attempting to detect whether there is a known numeraire-transform factor present (e.g. as a factor) in the current payment function. Numeraire-transform factors are described in more detail below. In the first iteration of block 206, the current payment function comprises input payment function 102, but as described in more detail below, the current payment function can be modified during the course of method 200 (e.g. when a numeraire-transform factor is eliminated from a payment function in block 208). The block 206 search for a numeraire-transform factor may be performed symbolically—e.g. using software, such as Maple™, Mathematica™, SymPy™ and/or the like. As discussed in more detail below, if such a numeraire-transform factor is detected in block 206, the block 206 numeraire-transform factor may subsequently be used to change the current numeraire/measure and to modify the current payment function in block 208.

Changes to a measure or numeraire may be achieved on the basis of Girsanov's theorem in accordance with the following mathematical development. A choice of a numeraire M(t) is an arbitrary positive function, so another numeraire M′(t) could be chosen for equation (1) such that:

$$V ( 0 ) = N α M ( 0 ) {𝔼}^{M} [ \frac{f ( \vec{x} )}{M ( t )} ] = N α {M}^{′} ( 0 ) {𝔼}^{{M}^{′}} [ \frac{f ( \vec{x} )}{{M}^{′} ( t )} ] \qquad ( 14 )$$

Given that the payment function ƒ(\vec{x}) is arbitrary, the numeraire M(t) may be absorbed into the payment function and equation (14) may be re-written:

[symbol]

^{M}[ƒ(\vec{x})]= [symbol] ^{M′}[ƒ(\vec{x})φ] (15)

where φ is the Radon-Nikodym derivative of the M measure with respect to the M′ measure,

$$φ = \frac{{M}^{′} ( 0 )}{M ( 0 )} \frac{M ( t )}{{M}^{′} ( t )} \qquad ( 16 )$$

The quantity

$$\frac{{M}^{′} ( 0 )}{M ( 0 )}$$

is a constant and may be referred to herein as a time-zero factor. Assuming that the current numeraire is M′(t), block 206 may involve looking for a factor

$$\frac{M ( t )}{{M}^{′} ( t )}$$

in the current payment function, where the current numeraire M′(t) is present in the denominator. The expression

$$\frac{M ( t )}{{M}^{′} ( t )}$$

of equation (16) may be referred to as a numeraire-transform factor. There are a number of numeraire-transform factors that are common in the context of payment functions associated with financial derivatives. Non-limiting examples of such numeraire-transform factors include the ratio of any two of the numeraires listed in Table 1 above.

If a numeraire-transform factor

$$\frac{M ( t )}{{M}^{′} ( t )}$$

is detected in ine payment function in block 206, then method 200 proceeds to block 208 which involves changing the current numeraire/measure and correspondingly modifying the current payment function. These block 208 changes may be performed in effort to reduce an otherwise non-linear payment function to a linear form, thereby potentially revealing the absence of convexity. In particular, where the current payment function has the form

$$f ( \vec{x} ) = \frac{M ( t )}{{M}^{′} ( t )} ψ ( s ) ,$$

then the numeraire-transform factor may be eliminated from the payment function, since

$${𝔼}^{{M}^{′}} [ f ( \vec{x} ) = {𝔼}^{{M}^{′}} [ \frac{M ( t )}{{M}^{′} ( t )} ψ ( s ) ] = \frac{M ( 0 )}{{M}^{′} ( 0 )} {𝔼}^{M} [ ψ ( s ) ] \qquad ( 93 )$$

where the stochastic variables \vec{x} are functions of s, indicating that the elements of \vec{x} are based on observations made at or before the time s, which in turn is at or before the payment time t. Thus, block 208 may involve modifying the current payment function by eliminating the numeraire-transform factor to arrive at a new payment function given by the right hand side of equation (93). In some embodiments, the modified payment function may take the form of ψ(s) in equation (93) and method 100 may comprise setting a flag or otherwise providing some technique for recalling that the final expectation (when valuated) should be multiplied by the time-zero factor

$$\frac{M ( 0 )}{{M}^{′} ( 0 )} .$$

Block 208 also involves changing the current measure/numeraire M′(t) to the new measure/numeraire M(t) as dictated by equation (93) and the block 206 numeraire-transform factor

$$\frac{M ( t )}{{M}^{′} ( t )}$$

used to modify the payment function. In some embodiments, the new current measure/numeraire is stored or otherwise maintained in an accessible format during the performance of method 100.

After modifying the current payment function and then modifying the corresponding current numeraire in block 208, the modified payment function becomes the current payment function and the modified measure/numeraire becomes the corresponding current measure/numeraire. Method 200 then returns to block 206 which comprises ascertaining whether there are further discernable numeraire-transform factors present in the new current payment function and (if possible) repeating the procedures of block 208 to further modify the payment function and the associated measure. It will be appreciated that the procedures of block 206 and 208 could be repeated a number of times, with each iteration comprising a change in the payment function, a corresponding change in the measure/numeraire and recording or otherwise flagging a suitable time-zero factor

$$\frac{M ( 0 )}{{M}^{′} ( 0 )} .$$

Returning, for a moment, to the block 206 evaluation, in some embodiments, the initial measure M′(t) for the input payment function 102 is the t-forward measure for a payment at time t where M′(t)=P(t, t)=1. In this case, equation (93) reduces to

$$\begin{matrix}{𝔼}^{{M}^{′}} [ f ( \vec{x} ) ] = {𝔼}^{{M}^{′}} [ M ( t ) ψ ( s ) ] \\ = {𝔼}^{t} [ M ( t ) ψ ( s ) ] \\ = \frac{M ( 0 )}{{M}^{′} ( 0 )} {𝔼}^{M} [ ψ ( s ) ] \\ = \frac{M ( 0 )}{P ( 0 , t )} {𝔼}^{M} [ ψ ( s ) ]\end{matrix} \qquad ( 94 )$$

In this case, the numeraire-transform factor is just M(t) and the block 206 evaluation reduces to an attempt to detect the presence of a factor corresponding to any numeraire.

In some embodiments, a procedure similar to that of block 204/method 250 of FIG. 3B (not shown) could be performed after each iteration of block 208 to check whether the block 208 modified payment function ψ(s) may be determined to be linear. If the modified payment function ψ(s) is determined to be linear in accordance with method 250, then an intrinsic value of the modified payment function ψ(s) could be determined in block 258. As discussed above, block 258 may also comprise determining the method 100 valuation 132 of the input payment function 102 (see FIG. 1) based on the block 258 intrinsic value of the modified payment function ψ(s) multiplied by suitable time-zero factor(s), appropriate constant(s) (e.g. N, α of equation (2)) and an appropriate discount factor (e.g. P^{B}(0, t) of equation (2))—see block 258 of method 250 described above. As discussed above, such a method 100 valuation 132 could also comprise an indication that it is an intrinsic value or that the input payment function lacks convexity.

If block 206 cannot detect a numeraire-transform factor (block 206 NO branch), then method 200 proceeds to block 207. Block 207 involves an inquiry as to whether method 200 might be able to use suitable modeling assumptions, which when implemented may expose a numeraire-transform factor in the current payment function. In some embodiments, such modeling assumptions may comprise or reduce to equations which can be substituted into the current payment function, as a basis for re-writing the current payment function in terms of different variables which in turn may expose a numeraire-transform factor.

FIG. 3C is a schematic depiction of a method 280 for performing an inquiry into whether there are suitable modeling assumptions that can be substituted into the current payment function and, if there are such modeling assumptions, for appropriate substitution of such modeling assumptions into the current payment function, according to a particular embodiment. In some embodiments, method 280 may be used to implement block 207 of method 200 of FIG. 3A. Method 280 begins in block 282 which comprises searching a library or catalog of embedded or otherwise accessible modeling assumptions (e.g. modeling assumptions that are accessible to the processor(s)/computer(s) performing method 100). Some embodiments comprise automating the block 282 inquiry into an appropriate choice of modeling assumptions based on such an accessible catalog of possible modeling assumptions. Such a catalog may not be prohibitively large, as long as the objective is to expose potential numeraire-transform factors, since, as discussed above, numeraire-transform factors are based on ratios of numeraires which are known.

As discussed above, modeling assumptions may comprise or reduce to equations which can be substituted into the current payment function. Block 282 may comprise a search of the modeling assumption catalog for variables matching those present in the current payment function, with a view to substituting the corresponding modeling assumption equation into the current payment function in effort to expose a numeraire-transform factor. If the block 282 inquiry is positive (i.e. there exists a suitable modeling assumption), then method 280 proceeds to block 288. In block 288, the modeling assumption is incorporated into the current payment function by substitution of the equation corresponding to the block 282 modeling assumption into the current payment function. This block 288 substitution may result in the exposure of a numeraire-transform factor in the current payment function. After the block 288 substitution, method 280 proceeds to block 290 which, in the illustrated embodiment, returns to the YES branch of block 207 of method 200 (FIG. 3A). From the YES branch of block 207 of method 200, method 200 proceeds to block 208. The procedures of block 208 may be substantially similar to those discussed above, except that the current payment function is that modified by the block 288 substitution based on the modeling assumption.

Returning to method 280 (FIG. 3C), if the block 282 inquiry is negative, then method 280 proceeds to optional block 284. Optional block 284 is similar to block 282 in the sense that it involves an inquiry as to whether there are suitable modeling assumptions that can be substituted into the current payment function to expose a numeraire-transform factor. Block 284 differs from block 282 in that block 284 comprises inquiring with the user as to whether the user is aware of, or would like to introduce, a suitable modeling assumption. If the block 284 inquiry is positive, then method 280 proceeds to blocks 288 and 290. Other than for the source of the modeling assumption (i.e. based on user input or based on automated searching of an accessible catalog), blocks 288 and 290 are similar to those discussed above. If the block 284 inquiry is negative, or optional block 284 is not present, then method 280 proceeds to block 286 which returns to the NO branch of block 207 of method 200 (FIG. 3A).

If both of the block 206 and block 207 inquiries are negative, then method 200 proceeds to block 210. Block 210 comprises a procedure similar to that of block 204 and may involve the performance of method 250 (FIG. 3B). However, for the purposes of block 210, method 250 would be performed on the current payment function (as modified by any block 208 modifications). The block 210 procedure may involve checking whether the current payment function could be determined to be linear. If the current payment function is determined to be linear in accordance with method 250, then an intrinsic value of the current payment function may be determined in block 258. If the current payment function is different than the input payment function 102, the intrinsic value of the input payment function 102 could be determined in block 258 by multiplication of the intrinsic value of the current payment function by suitable time-zero factor(s). Further, the method 100 valuation 132 of the input payment function 102 (see FIG. 1) could be determined in block 258 by multiplication of the intrinsic value of the input payment function 102 by appropriate constant(s) (e.g. N, α of equation (2)) and an appropriate discount factor (e.g. P^{B}(0, t) of equation (2))). These multiplication procedures are described above in connection with block 258 of method 250. As discussed above, the method 100 valuation 132 could also comprise an indication that valuation 132 is an intrinsic value or that the input payment function lacks convexity. If the block 210 procedure is not able to detect linearity (i.e. the absence of convexity), then method 250 may return to node B, rather than node A.

We now consider the loops of blocks 206/208 and/or 207/208 in relation to a number of the examples presented above. Consider, by way of non-limiting example, the Example C forward rate agreement, whose valuation takes the form:

$${V}_{FRA} ( 0 ) = N α P ( 0 , s ) {𝔼}^{s} [ \frac{{L}_{st} ( a ) - k}{1 + α {L}_{st} ( a )} ] \qquad ( 10 )$$

where k is the constant, quoted rate for the forward rate agreement, s is the payment time and Lₛₜ (a) is an annualized rate for the period that runs from s to t in currency B at a fixing time a. The initial measure of the expectation of this payment function is the payment-time-forward measure, which is the s-forward measure in the case of Example C. Accordingly, the initial numeraire for Example C is M′(τ)=P(τ, s). When method 200 is applied to Example C, method 200 may take advantage of a suitable modeling assumption in block 207 (e.g. via method 280 of FIG. 3C). In general, a discrete forward discount rate Rₛₜ(a) is given by

$${R}_{st} ( a ) = \frac{1}{α} ( \frac{1}{{P}_{a} ( s , t )} - 1 ) = \frac{1}{α} ( \frac{P ( a , s )}{P ( a , t )} - 1 ) \qquad ( 100 )$$

where we adopt the notation

$${P}_{a} ( s , t ) = \frac{P ( a , t )}{P ( a , s )} .$$

We can express me Libor rate Lₛₜ(a) as

Lₛₜ(a)=Rₛₜ(a)+Sₛₜ(a) (101)

where Sₛₜ(a) is the spread between the Libor rate Lₛₜ(a) and the discount rate Rₛₜ(a). However, if a modeling assumption is adopted that there is no spread between the Libor rate Lₛₜ(a) and the discount rate Rₛₜ(a) (i.e. Sₛₜ(a)=0), then equations (100) and (101) may be combined to yield the modeling assumption equation

$${L}_{st} ( a ) = {R}_{st} ( a ) = \frac{1}{α} ( \frac{P ( a , s )}{P ( a , t )} - 1 ) \qquad ( 102 )$$

The assumption that there is no spread (i.e. Sₛₜ(a)=0) is useful for the purposes of explanation, but may actually be an oversimplification, in some circumstances. In some embodiments, it is sufficient to assume that there is no correlation between the spread Sₛₜ(a) and the discount rate Rₛₜ(a) and we may arrive at the same result for Example C. This modeling equation (102) can be substituted into the denominator of equation (10) (e.g. in block 288 of FIG. 3C) to yield

$${V}_{FRA} ( 0 ) = N α P ( 0 , s ) {𝔼}^{s} [ \frac{{L}_{st} ( a ) - k}{\frac{P ( a , s )}{P ( a , t )}} ] = N α P ( 0 , s ) {𝔼}^{s} [ ( {L}_{st} ( a ) - k ) \frac{P ( a , t )}{P ( a , s )} ] \qquad ( 103 )$$

With this modeling-assumption-based substitution, method 200 may identify a numeraire-transform factor in equation (103). In particular, the current measure is the s-forward measure M′(τ)=P(τ, s) and the target measure is the t-forward measure M(τ)=P(τ, t) and so

$$\frac{P ( a , t )}{P ( a , s )}$$

may be seen to be the numeraire-transform factor

$$\frac{M ( τ )}{{M}^{′} ( τ )}$$

evaluated at the time τ=a. This numeraire-transform factor may then be removed from equation (103) (e.g. in block 208 and in accordance with equation (93) using

$$\frac{M ( τ )}{{M}^{′} ( τ )}$$

in the place of

$$\frac{M ( t )}{{M}^{′} ( t )}$$

since t is already provided with a meaning in the context of Example C) to yield

$$\begin{matrix}{V}_{FRA} ( 0 ) = N α P ( 0 , s ) {𝔼}^{s} [ ( {L}_{st} ( a ) - k ) \frac{P ( a , t )}{P ( a , s )} ] \\ = N α P ( 0 , s ) \frac{P ( 0 , t )}{P ( 0 , s )} {𝔼}^{t} [ ( {L}_{st} ( a ) - k ) ]\end{matrix} \qquad ( 104 )$$

where equation (104) incorporates the time-zero factor

$$\frac{M ( 0 )}{{M}^{′} ( 0 )} = \frac{P ( 0 , t )}{P ( 0 , s )} .$$

After the extraction of the numeraire-transform factor in accordance with equation (104), the resultant payment function is Lₛₜ(a)−k (i.e. the expression inside the expectation on the rightmost side of equation (104)) and the resultant measure is the t-forward measure. This payment function and measure become the new current payment function and the new current measure respectively. This new current payment function has a single stochastic variable, Lₛₜ(a), whose natural measure is also the t-forward measure (which is the same as the new current measure) and would be evidently linear (lacking convexity) to suitable symbolic algebra software. Accordingly, method 200 may determine the equation (104) valuation intrinsically (e.g. in block 258 of FIG. 3B) to be

$${V}_{FRA} ( 0 ) = N α P ( 0 , s ) \frac{P ( 0 , t )}{P ( 0 , s )} {𝔼}^{t} [ ( {L}_{st} ( a ) - k ) ] = N α P ( 0 , s ) \frac{P ( 0 , t )}{P ( 0 , s )} [ ( {\overline{L}}_{st} ( a ) - k ) ] \qquad ( 105 )$$

where we adopt the notation \vec{L}ₛₜ(a)= [symbol] ^{t}[Lₛₜ(a)].

By way of validation, it may be demonstrated that [symbol] ^{t} [Lₛₜ(a)]= L̅ₛₜ(a)= L̅ₛₜ(0). For Lₛₜ (0), equation (102) becomes

$${L}_{st} ( 0 ) = {\overline{L}}_{st} ( a ) = \frac{1}{α} ( \frac{P ( 0 , s )}{P ( 0 , t )} - 1 )$$

or, rearranging this expression,

$$\frac{P ( 0 , t )}{P ( 0 , s )} = \frac{1}{1 + α {\overline{L}}_{st} ( a )} ( which is also the time \text{-} zero factor ) . \\ Substituting for the time \text{-} zero factor \frac{P ( 0 , t )}{P ( 0 , s )}$$

in the middle expression of equation (105) yields

$${V}_{FRA} ( 0 ) = N α P ( 0 , s ) \frac{1}{1 + α {\overline{L}}_{st} ( a )} {𝔼}^{t} [ ( {L}_{st} ( a ) - k ) ] = N α P ( 0 , s ) \frac{{\overline{L}}_{st} ( a ) - k}{1 + α {\overline{L}}_{st} ( a )} \qquad ( 106 )$$

Accordingly, from equations (10) and (106) we have

$${V}_{FRA} ( 0 ) = N α P ( 0 , s ) {𝔼}^{s} [ \frac{{L}_{st} ( a ) - k}{1 + α {L}_{st} ( a )} ] = N α P ( 0 , s ) \frac{{\overline{L}}_{st} ( a ) - k}{1 + α {\overline{L}}_{st} ( a )} \qquad ( 107 )$$

which demonstrates that the valuation of the Example C forward rate agreement (FRA) is given by its intrinsic value and therefore lacks convexity. As discussed in connection with Example C, method 200 may involve moving from the s-forward measure to the t-forward measure to recognize this lack of convexity.

The absence of convexity in the above-discussed Example E situation may also be detected using the procedures of blocks 206, 208 and 210. Because Example E involves multiple currencies, we use currency labels A and B to keep track of the different currencies. We start with the input payment function 102 whose valuation is given by

V_{B}(0)=NαP^{B}(0,t) [symbol] ^{B,t}[S_{A}(s)X_{AB}(t)] (108)

where: S_{A}(s) represents a stock price in currency A observed at time s, typically a small number of business days before t, according to the settlement conventions in the given market; the expression inside the expectation (S_{A}(s)X_{AB} (t)) represents input payment function 102 which is the B-currency worth of A-currency stock; and P^{B}(0, t) indicates that the valuation is in currency B and payment is at time t. Method 200 may identify a numeraire-transform factor in equation (108)—e.g. in block 206. In particular, the current measure is M′(τ)=P^{B}(τ, t) and the target measure is M(τ)=P^{A} (τ, t)X_{AB}(τ) and so we may identify a numeraire-transform factor

$$\frac{M ( τ )}{{M}^{′} ( τ )} .$$

$$\frac{M ( τ )}{{M}^{′} ( τ )} = \frac{{P}^{A} ( τ , t ) {X}_{AB} ( τ )}{{P}^{B} ( τ , t )} \qquad ( 109 )$$

However, since the Example E payment time is time t, we may put t in the place of the arbitrary time variable τ in equation (109) to yield the numeraire-transform factor

$$\frac{M ( t )}{{M}^{′} ( t )} = {X}_{AB} ( t ) ,$$

where we recognize that P^{A}(t, t)=P^{B}(t, t)=1. This numeraire-transform factor

$$\frac{M ( t )}{{M}^{′} ( t )} = {X}_{AB} ( t )$$

may then be removed from equation (108) (e.g. in block 208 and in accordance with equation (93)) to yield

$${V}_{B} ( 0 ) = N α {P}^{B} ( 0 , t ) {𝔼}^{B , t} [ {S}_{A} ( s ) {X}_{AB} ( t ) ] = N α {P}^{B} ( 0 , t ) \frac{{P}^{A} ( 0 , t ) {X}_{AB} ( 0 )}{{P}^{B} ( 0 , t )} {𝔼}^{A , t} [ {S}_{A} ( s ) ] \qquad ( 110 )$$

where equation (110) incorporates the time-zero factor

$$\frac{M ( 0 )}{{M}^{′} ( 0 )} = \frac{{P}^{A} ( 0 , t ) {X}_{AB} ( 0 )}{{P}^{B} ( 0 , t )}$$

obtained by substituting τ=0 into equation (109).

After the extraction of the numeraire-transform factor in accordance with equation (110), the resultant payment function is S_{A}(s) (i.e. the expression inside the expectation on the rightmost side of equation (110)) and the resultant measure is the A-currency, t-forward measure. This payment function and measure become the new current payment function and the new current measure respectively. This new current payment function has a single stochastic variable, S_{A}(s), whose natural measure is also the A-currency, t-forward measure (which is the same as the new current measure) and would be evidently linear (lacking convexity) to suitable symbolic algebra software. Accordingly, method 200 may determine the equation (110) valuation intrinsically (e.g. in block 258 of FIG. 3B) to be

$$\begin{matrix}{V}_{B} ( 0 ) = N α {P}^{B} ( 0 , t ) \frac{{P}^{A} ( 0 , t ) {X}_{AB} ( 0 )}{{P}^{B} ( 0 , t )} {𝔼}^{A , t} [ {S}_{A} ( s ) ] \\ = N α {P}^{B} ( 0 , t ) \frac{{P}^{A} ( 0 , t ) {X}_{AB} ( 0 )}{{P}^{B} ( 0 , t )} {\overline{S}}_{A} ( s )\end{matrix} \qquad ( 110 )$$

where we adopt the notation S̅_{A}(s)= [symbol] ^{A,t}[S_{A}(s)].

By way of validation, it may be demonstrated from interest rate parity that the intrinsic value X̅_{AB}(t) of the FX rate is given by

$${\overline{X}}_{AB} ( t ) = \frac{{P}^{A} ( 0 , t ) {X}_{AB} ( 0 )}{{P}^{B} ( 0 , t )} .$$

Accordingly, equation (110) may be re-written as

V_{B}(0)=NαP^{B}(0,t) X̅_{AB}(t) S̅_{A}(s) (111)

Accordingly, from equations (108) and (111) we have

V_{B}(0)=NαP^{B}(0,t) [symbol] ^{B,t}[S_{A}(s)X_{AB}(t)]=NαP^{B}(0,t) X̅_{AB}(t) S̅_{A}(s) (112)

which demonstrates that the valuation of the Example E asset in a foreign currency is given by its intrinsic value and therefore lacks convexity. As discussed in connection with Example E, method 200 may involve a numeraire change to recognize this lack of convexity.

As discussed above, the block 206/207/208 measure change procedure may be applied iteratively. For some payment functions, multiple numeraire-transform factors are present, and so while a linear payment function may not appear after a first iteration of blocks 206, 207 and 208, by repeated application of the block 206/207/208 measure change operation, a linear payment function may eventually be discerned. The Example G compounded rate payment function described above includes two numeraire-transform factors. Under the same block 207 modeling assumptions that were applied in the case of Example C discussed above (i.e. there is no spread between the discount rate Rₛₜ(a) and either of the rates L₁ or L₂), then modeling assumption equations similar to equation (102) can be derived for the rates L₁ and L₂. In particular:

$$\begin{matrix}{L}_{2} ( a ) = \frac{1}{α} ( \frac{P ( a , {t}_{1} )}{P ( a , {t}_{2} )} - 1 ) \\ and & ( 113 a ) \\ {L}_{1} ( a ) = \frac{1}{α} ( \frac{P ( a , {t}_{0} )}{P ( a , {t}_{1} )} - 1 ) & ( 113 b )\end{matrix}$$

In a manner similar to that of Example C described above, it may be shown that

$$\begin{matrix}{\overline{L}}_{2} ( a ) = {L}_{2} ( 0 ) = \frac{1}{α} ( \frac{P ( 0 , {t}_{1} )}{P ( 0 , {t}_{2} )} - 1 ) \\ and that & ( 114 a ) \\ {\overline{L}}_{1} ( a ) = {L}_{1} ( 0 ) = \frac{1}{α} ( \frac{P ( 0 , {t}_{0} )}{P ( 0 , {t}_{1} )} - 1 ) & ( 114 b )\end{matrix}$$

or, rearranging the terms, that

$$\begin{matrix}\frac{P ( 0 , {t}_{2} )}{P ( 0 , {t}_{1} )} = \frac{1}{1 + α {\overline{L}}_{2}} \\ and that & ( 115 a ) \\ \frac{P ( 0 , {t}_{1} )}{P ( 0 , {t}_{0} )} = \frac{1}{1 + α {\overline{L}}_{1}} & ( 115 b )\end{matrix}$$

where we have dropped the argument from L₂ and L₁ in equations (115a) and (115b).

We start with the Example G input payment function 102 whose valuation is given by

V_{B}(0)=NαP(0,t₂) [symbol] ^{t}^{₂}[(1+αL₁)(1+αL₂)] (116)

Substituting the assumption of equation (113a) into equation (116) (e.g. in block 288 of FIG. 3C) yields

$${V}_{B} ( 0 ) = N α P ( 0 , {t}_{2} ) {𝔼}^{{t}_{2}} [ ( 1 + α {L}_{1} ) \frac{P ( a , {t}_{1} )}{P ( a , {t}_{2} )} ] \qquad ( 117 )$$

Method 200 may identify a first numeraire-transform factor

$$\frac{{M}^{′} ( t )}{{M}^{″} ( t )}$$

in equation (117). In particular, the current measure is the t₂-forward measure M″(τ)=P(τ, t₂) and the target measure is the t₁-forward measure M′(τ)=P(τ, t₁) and so

$$\frac{P ( a , {t}_{1} )}{P ( a , {t}_{2} )} \qquad ( 118 )$$

may be seen to be the numeraire-transform factor

$$\frac{M ( τ )}{{M}^{′} ( τ )}$$

evaluated at the time τ=a. This numeraire-transform factor may then be removed from equation (117) (e.g. in block 208 and in accordance with equation (93) using

$$\frac{M ( τ )}{{M}^{′} ( τ )}$$

in the place of

$$\frac{M ( t )}{{M}^{′} ( t )} )$$

to yield

$$\begin{matrix}{V}_{B} ( 0 ) = N α P ( 0 , {t}_{2} ) {𝔼}^{{t}_{2}} [ ( 1 + α {L}_{1} ) \frac{P ( α , {t}_{1} )}{P ( α , {t}_{2} )} ] \\ = N α P ( 0 , {t}_{2} ) \frac{P ( 0 , {t}_{1} )}{P ( 0 , {t}_{2} )} {𝔼}^{{t}_{1}} [ ( 1 + α {L}_{1} ) ]\end{matrix} \qquad ( 119 )$$

where equation (104) incorporates the time-zero factor

$$\frac{{M}^{′} ( 0 )}{{M}^{″} ( 0 )} = \frac{P ( 0 , {t}_{1} )}{P ( 0 , {t}_{2} )} .$$

Substituting equation (115a) into the rightmost expression of equation (119) yields:

V_{B}(0)=NαP(0,t₂)(1+α L̅₂) [symbol] ^{t}^{₁}[(1+αL₁)] (120)

Equation (120) may then become the current payment function for another iteration of the block 206/207/208 loop. In particular, substituting the assumption of equation (113b) into equation (120) (e.g. in block 288 of FIG. 3C) yields

$${V}_{B} ( 0 ) = N α P ( 0 , {t}_{2} ) ( 1 + α {\overline{L}}_{2} ) {𝔼}^{{t}_{1}} [ \frac{P ( a , {t}_{0} )}{P ( a , {t}_{1} )} ] \qquad ( 121 )$$

Method 200 may identify a second numeraire-transform factor

$$\frac{M ( t )}{{M}^{′} ( t )}$$

in equation (121). In particular, the current measure is the t₁-forward measure M′(τ)=P(τ, t₁) and the target measure is the t₀-forward measure M(τ)=P(τ, t₀) and so

$$\frac{P ( a , {t}_{0} )}{P ( a , {t}_{1} )} \qquad ( 122 )$$

may be seen to be the numeraire-transform factor

$$\frac{M ( τ )}{{M}^{′} ( τ )}$$

evaluated at the time τ=a. This numeraire-transform factor may then be removed from equation (121) (e.g. in block 208 and in accordance with equation (93) using

$$\frac{M ( τ )}{{M}^{′} ( τ )}$$

in me place of

$$\frac{M ( t )}{{M}^{′} ( t )} )$$

to yield

$$\begin{matrix}{V}_{B} ( 0 ) = N α P ( 0 , {t}_{2} ) ( 1 + α {\overline{L}}_{2} ) {𝔼}^{{t}_{1 }} [ \frac{P ( a , {t}_{0} )}{P ( a , {t}_{1} )} ] \\ = N α P ( 0 , {t}_{2} ) ( 1 + α {\overline{L}}_{2} ) \frac{P ( 0 , {t}_{0} )}{P ( 0 , {t}_{1} )} {𝔼}^{{t}_{0}} [ 1 ]\end{matrix} \qquad ( 123 )$$

where equation (104) incorporates the time-zero factor

$$\frac{M ( 0 )}{{M}^{′} ( 0 )} = \frac{P ( 0 , {t}_{0} )}{P ( 0 , {t}_{1} )} .$$

After the extraction of the second numeraire-transform factor in accordance with equation (123), the resultant payment function is unity (i.e. the expression inside the expectation on the rightmost side of equation (123)) and the resultant measure is the t₀-forward measure. This payment function and measure become the new current payment function and the new current measure respectively. This new current payment function has no stochastic variables (block 251 NO branch) and would be evidently linear (lacking convexity) to suitable symbolic algebra software. Accordingly, method 200 may determine the equation (123) valuation intrinsically (e.g. in block 258 of FIG. 3B).

By way of validation, we may substitute equation (115b) into the rightmost expression of equation (123) and recognize that [symbol] ^{t}^{₀}[1]=1 to yield:

V_{B}(0)=NαP(0,t₂)(1+α L̅₂)(1+α L̅₁) (124)

Accordingly, from equations (116) and (124) we have

V_{B}(0)=NαP(0,t₂) [symbol] ^{t}^{₂}[(1+αL₁)(1+αL₂)]=NαP(0,t₂)(1+α L̅₂)(1+α L̅₁) (125)

which demonstrates that the valuation of the Example G compounded rate is given by its intrinsic value and therefore lacks convexity. As discussed in connection with Example G, method 200 may involve moving from the t₂-forward measure to the t₁-forward measure and then to the t₀-forward measure to recognize this lack of convexity.

Returning now to method 200 of FIG. 3A, if it is not possible (using the procedures of blocks 206, 207, 208, 210) to determine an absence of convexity in the current payment function or to valuate input payment function 102 based on an intrinsic value of the current payment function (with suitable time-zero factors), then method 200 proceeds to block 212 which involves collecting the remaining stochastic variables (underlyings) in the current payment function and determining whether a unique natural measure exists for all of the remaining underlyings. If there is a unique natural measure for all of the underlyings (block 212 YES branch), then method 200 proceeds to block 214 which comprises going to block 120 (FIG. 1) and changing the current measure to match the unique natural measure of the underlyings of the current payment function.

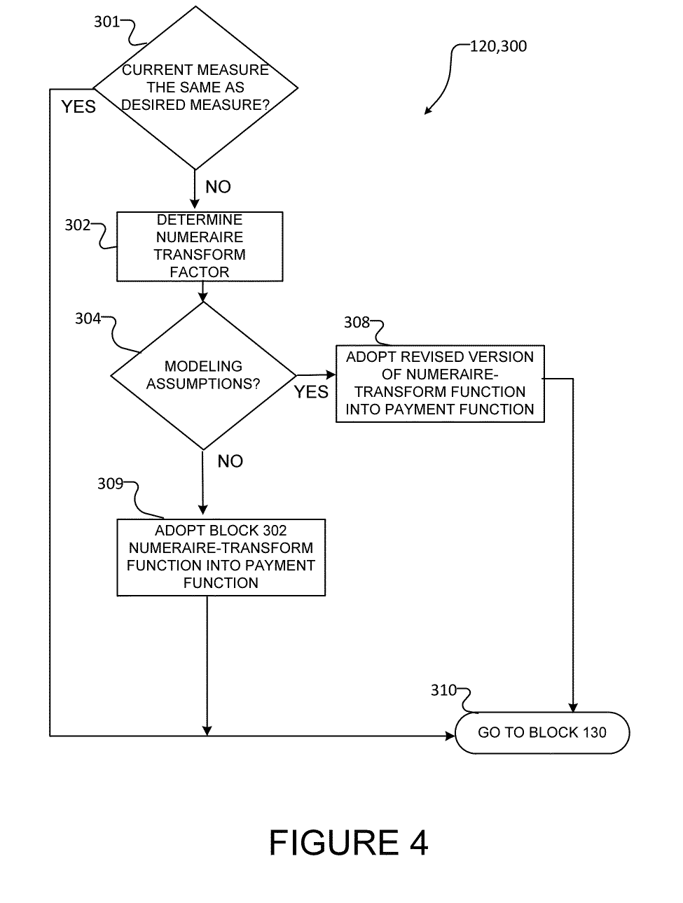

FIG. 4 is a schematic depiction of a method 300 for changing the current measure to a desired measure (e.g. to the unique natural measure of the underlyings of the current payment function and/or to a suitable replication measure discussed in more detail below). In some embodiments, method 300 of FIG. 4 may be used to implement block 120 of FIG. 1. If block 120/method 300 is being used, it means that the previous method 200 efforts to detect the absence of convexity were unsuccessful. For example, convexity may be present in the payment function, or the absence of convexity may be hidden in some way. Non-limiting examples of the way that convexity could be hidden, include: by a complicated functional form (which could conceivably be rendered linear with suitable algebraic simplification if available) and/or by a mismatch between the current measure and the natural measure of the stochastic variables underlying the payment function. However, method 100 may still detect this hidden linearity—e.g. using numerical techniques.

Method 300 commences in block 301 which comprises comparing the current measure to the desired measure (e.g. to the unique natural measure of the underlyings of the current payment function or to the desired replication measure). If the current measure and the desired measure are the same (block 301 YES branch), then method 300 proceeds to block 310 where it ends and proceeds to block 130 of method 100 (FIG. 1). If, on the other hand, the current measure and the desired measure are different (block 301 NO branch), then method 300 proceeds to block 302. Block 302 comprises determining a numeraire-transform factor which (if injected into the current payment function) would transform the current measure to match the desired measure (e.g. the unique natural measure of the underlyings of the current payment function or the desired replication measure). It will be appreciated from the discussion above, that injecting a numeraire-transform factor into the current payment function results in a change of the current payment function, but also involves a corresponding change in the current measure and the creation of a corresponding time-zero factor. Such changes in the current measure and corresponding time-zero factors may also be determined as a part of block 302 and may be handled in the same manner discussed above.

An aim of the numeraire-transform factor determined in block 302 may be to facilitate eventual estimation of the expectation of the resultant payment function by using a suitable replication procedure (e.g. replication based on a suitable portfolio of options). Replication procedures are discussed in more detail below. However, injection of the block 302 numeraire-transform factor into the payment function may introduce additional stochastic variables into the payment function, which may in turn result in increasing the dimensionality of the replication procedure. In general, the size and complexity of replication procedures scale exponentially with the number of variables in the target payment function. Consequently, it may, in some embodiments, be desirable to attempt to minimize or reduce the dimensionality of the payment function that would result from injection of the block 302 numeraire-transform factor into the payment function.

In some embodiments, method 300 may optionally comprise a procedure which attempts to avoid increasing (or minimizing the increase of) the dimensionality of the payoff function. This aspect of method 300 may be performed for some block 302 numeraire-transform factors under suitable modeling assumptions. Method 300 may first proceed to block 304 which comprises inquiring as to whether suitable modeling instructions are available (e.g. based on user input, a suitable catalog of instructions, from some external source and/or the like). In some embodiments, the block 304 inquiry may be performed using method 280 of FIG. 3C, except that rather than looking for modeling assumptions and corresponding modeling equations that will expose a numeraire-transform factor (as is the case when method 280 is used to implement the block 207 inquiry), when method 280 is used to implement the block 304 inquiry, method 280 is looking for modeling assumptions and corresponding modeling equations that could be used to reduce the dimensionality of the payment function after injection of the block 302 numeraire-transform factor. In some embodiments, such modeling assumptions and corresponding equations may attempt to express the block 302 numeraire-transform factor in terms of variables that are already part of the current payment function—e.g. by substitution of the modeling equation into the block 302 numeraire-transform factor to express the block 302 numeraire-transform factor in terms of variables that are already present in the current payment function.

As is the case when method 280 is used to implement the block 207 inquiry as described above, when method 280 is used to implement the block 304 inquiry, it may comprise a search for suitable modeling assumptions in an accessible catalog or the like in block 282 and, optionally, a user-assisted inquiry for suitable modeling assumptions in optional block 284. If both of these block 282 and 284 inquires are negative, then method 280 proceeds to block 286 where it then returns to the NO branch of block 304 (FIG. 4). From the NO branch of block 304, method 300 proceeds to block 309 which involves injecting the block 302 numeraire-transform factor directly into the payment function, changing the current measure accordingly and keeping track of the associated time-zero factors. Method 300 then proceeds to block 310 where it ends and proceeds to block 130 of method 100 (FIG. 1).

Returning to FIG. 3C, if either of the block 282 or 284 inquiries are positive, then method 280 proceeds to block 288. When method 280 is used to implement the block 304 inquiry according to the illustrated embodiment, block 288 involves substituting the modeling assumption equation into the block 302 injected numeraire-transform factor (rather than into the current payment function as is the case when method 280 used to implement the block 207 inquiry described above). After the block 288 substitution, method 280 proceeds to block 290, where it then returns to the YES branch of block 304 (FIG. 4). From the YES branch of block 304, method 300 proceeds to block 308 which involves injecting the revised version of the block 302 numeraire-transform factor (e.g. the version of the block 302 numeraire-transform factor which incorporates the modeling assumption and the corresponding substitution from block 288 of method 280 (FIG. 3C)). Block 308 may also comprise changing the current measure according to the injected numeraire-transform factor and keeping track of the associated time-zero factors. Method 300 then proceeds to block 310 where it ends and proceeds to block 130 of method 100 (FIG. 1).

Consider the Example D Libor in Arrears payment function whose valuation in given by

V_{LIA}(0)=NαP(0,s) [symbol] ^{s}[Lₛₜ(a)] (126)

The natural measure of the underlying Lₛₜ(a) is the t-forward measure. However, as can be seen from equation (126), the initial measure of the expectation of the payment function is the s-forward measure. Because of this difference in the current measure and the natural measure of the underlying and because there may not be any obvious numeraire-transform factors or modeling assumptions, the Example D payment function may end up in block 212. However, because Example D has only a single underlying Lₛₜ(a) (as can be seen from equation (126), the block 212 inquiry is positive and the method proceeds to block 120 (e.g. method 300). Block 302 comprises a search for a numeraire-transform factor, which, when injected into the payment function, will modify the current measure (in this case, the s-forward measure given by M(τ)=P(τ, s)) to a desired measure (e.g. in this case the natural t-forward measure of the underlying Lₛₜ(a) given by M′(τ)=P(τ, t)).

Equation (93) may be rearranged as follows:

$${𝔼}^{M} [ ψ ( s ) ] = \frac{{M}^{′} ( 0 )}{M ( 0 )} {𝔼}^{{M}^{′}} [ \frac{M ( t )}{{M}^{′} ( t )} ψ ( s ) ] \qquad ( 127 )$$

Block 302 may involve determining the numeraire-transform factor to be

$$\frac{M ( a )}{{M}^{′} ( a )}$$

to be

$$\frac{P ( a , s )}{P ( a , t )}$$

where the time argument of each numeraire is in this case, as with Example C above, time a, the observation (fixing) time of the Libor rate. When such a numeraire-transform factor is injected into equation (126) in accordance with equation (127), the valuation function becomes

$${V}_{LIA} ( 0 ) = N α P ( 0 , s ) {𝔼}^{s} [ {L}_{st} ( a ) ] = N α P ( 0 , s ) \frac{P ( 0 , t )}{P ( 0 , s )} {𝔼}^{t} [ \frac{P ( a , s )}{P ( a , t )} {L}_{st} ( a ) ] \qquad ( 128 )$$

where we have also inserted the corresponding inverted time-zero factor

$$\frac{{M}^{′} ( 0 )}{M ( 0 )} = \frac{P ( 0 , t )}{P ( 0 , s )}$$

into equation (128). From the discussion of Example C above, we recall that

$$\frac{P ( 0 , t )}{P ( 0 , s )} = \frac{1}{1 + α {\overline{L}}_{st} ( a )}$$

to yield

$${V}_{LIA} ( 0 ) = N α P ( 0 , s ) \frac{P ( 0 , t )}{P ( 0 , s )} {𝔼}^{t} [ \frac{P ( a , s )}{P ( a , t )} {L}_{st} ( a ) ] = N α P ( 0 , s ) \frac{1}{1 + α {L}_{st} ( a )} {𝔼}^{t} [ \frac{P ( a , s )}{P ( a , t )} {L}_{st} ( a ) ] \qquad ( 129 )$$

From equation (129), it would appear that the block 302 injection has introduced additional stochastic variables into the expectation. However, as discussed above in connections with block 304, modelling assumptions may be substituted into the block 302 numeraire-transform factor in effort to express the block 302 numeraire-transform factor in terms of the stochastic variables already present in the payment function. We recall the modeling assumptions from the Example C case which are expressed in equation (102) and which may be rearranged to provide

$$\frac{P ( a , s )}{P ( a , t )} = 1 + α {L}_{st} ( a ) \qquad ( 130 )$$

The modelling assumption equation (130) may be substituted into the injected numeraire-transform factor or into the rightmost expression of equation (129) to give

$${V}_{LIA} ( 0 ) = N α P ( 0 , s ) \frac{1}{1 + α {\overline{L}}_{st} ( a )} {𝔼}^{t} [ ( 1 + α {L}_{st} ( a ) ) {L}_{st} ( a ) ] \qquad ( 129 )$$

which is non-linear, but which is expressed in terms of a single stochastic variable and is suitable for the replication techniques described herein.

In some cases, it might not be possible to re-write or re-express the block 302 numeraire-transform factor in terms of the stochastic variables already present in the payment function. In such cases, method 300 ends up in block 309. The Example F equity quanto is an example of such a scenario. The valuation of the Example F payment function is given by

V_{Q}^{B}(0)=NαP^{B}(0,t) [symbol] ^{B,t}[S_{A}(s)] (130)

The natural measure of the underlying S_{A}(s) is the currency A, t-forward measure whereas the measure associated with the expectation of the payment function is the currency B, t-forward measure. Block 302 comprises a search for a numeraire-transform factor, which, when injected into the payment function, will modify the current measure (in this case, the currency B, t-forward measure given by

$$M ( τ ) = \frac{{P}^{B} ( τ , t )}{{X}_{AB} ( τ )} )$$

to a desired measure (e.g. in this case the currency A, t-forward measure of the underlying S_{A}(s) given by M′(τ)=P^{A} (τ, t)).

Block 302 may involve determining the numeraire-transform factor to be

$$\frac{M ( τ )}{{M}^{′} ( τ )}$$

to be

$$\frac{{P}^{B} ( τ , t )}{{X}_{AB} ( τ ) {P}^{A} ( τ , t )}$$

which, when evaluated at time t reduces to

$$\frac{1}{{X}_{AB} ( t )} .$$

When such a numeraire-transform factor is injected into equation (130) in accordance with equation (127), the valuation function becomes

$$\begin{matrix}{V}_{Q}^{B} ( 0 ) = N α {P}^{B} ( 0 , t ) {𝔼}^{B , t} [ {S}_{A} ( s ) ] \\ = N α {P}^{B} ( 0 , t ) \cdot \frac{{P}^{A} ( 0 , t ) {X}_{AB} ( 0 )}{{P}^{B} ( 0 , t )} {𝔼}^{A , t} [ \frac{1}{{X}_{AB} ( t )} \cdot {S}_{A} ( s ) ]\end{matrix} \qquad ( 131 )$$

Which reduces further in view of the interest rate parity equation discussed above in connection with Example E

$$( i . e . {\overline{X}}_{AB} ( t ) = \frac{{P}^{A} ( 0 , t ) {X}_{AB} ( 0 )}{{P}^{B} ( 0 , t )} )$$

to

$${V}_{Q}^{B} ( 0 ) = N α {P}^{B} ( 0 , t ) \cdot {\overline{X}}_{AB} ( t ) {𝔼}^{A , t} [ \frac{{S}_{A} ( s )}{{X}_{AB} ( t )} ] \qquad ( 132 )$$

With this numeraire injection, the expectation of equation (131) is in the natural measure of the underlying stock. However, the payment function is non-linear (so we cannot use its intrinsic value) and a two-dimensional replication may be used to numerically determine its valuation.

Returning, for a moment, to method 200 (FIG. 3A), if the block 212 inquiry is negative (block 212 NO branch), then method 200 proceeds to 216. In block 216, it is known that the underlyings of the current payment function are associated with more than one natural measure. Block 216 involves an inquiry as to whether method 100 includes replication analytics (e.g. suitably configured option-pricing routines) which can handle the disparate underlyings of the current payment function. If the block 216 inquiry is negative, then method 200 proceeds to block 220 which comprises concluding that no automatic convexity determination is possible (at least by method 100). Block 220 may comprise returning the method 100 indication 134 (see FIG. 1) that method 100 is unable to valuate the input payment function 102 without using a Monte Carlo simulation or some other form of computationally expensive and/or complex modeling technique. Indication 134 of method 100 is described above.

If, on the other hand, the block 216 inquiry is positive (block 216 YES branch), then method 200 proceeds to block 218. Block 218 also involves proceeding to block 120 of FIG. 1 (e.g. method 300 of FIG. 4). However, instead of changing the current measure to match the unique natural measure of the underlyings (as was the case discussed above, where method 200 reaches block 120/method 300 via block 214), where method 200 proceeds to block 120/method 300 via block 218, block 120/method 300 involves changing the current measure to match a replication measure suitable for the replication analytics. In some embodiments, such replication analytics may comprise replication modeling based on option pricing in which case the replication measure may be referred to as an option-pricing measure. Other than for the target or desired measure (the unique natural measure of the underlyings (via block 214) or the replication measure (via block 218)), the procedures of block 120 are the same and may be implemented, in some embodiments, using method 300 described above, except with a different desired measure.

As discussed above, where block 120 is implemented by method 300 (or otherwise), at the conclusion of block 120, method 100 proceeds to block 130. When method 100 reaches block 130, the current payoff function either contains convexity or has eluded the previous method 100 attempts to detect the absence of convexity. In some embodiments, method 100 may attempt to proceed further in block 130 toward detecting convexity or the absence of convexity using symbolic algebra (e.g. using suitable symbolic algebra software, such as Maple™, Mathematica™, SymPy™ and/or the like). In some embodiments, block 130 comprises using numerical replication techniques.

Replication may be used to numerically evaluate payment functions, including linear and/or non-linear payment functions. One suitable technique for replicating payment functions that may be used in some embodiments comprises replication based European options. Any twice differentiable function of a single variable f(x) can be written as

ƒ(x)=ƒ(x₀)+ƒ′(x₀)(x−x₀)+∫ₓ^{x}^{₀}ƒ″(k)(k−x)⁺dk+∫ₓ_{₀}^{x}ƒ″(k)(x−k)⁺dk (52)

where the (·)⁺ indices refer to the positive part of the content of the parentheses and where ƒ′(x₀) indicates

$$\frac{d f}{d x}$$

evaluated at x=0. Equation (52) is a mathematical identity, quite independent from any financial modeling. By applying the expectation P(0,t) [symbol] [·] to both sides of equation (52), we obtain the present value of the function ƒ(x) as a function of a constant term, a forward term and an integral over European option prices—puts for x<x₀ and calls for x>x₀. A suitable choice for x₀ in some embodiments is the forward, or expected, value of x, in which case the linear term disappears. Integrals may be replaced by sums in the discrete context, yielding an approximation method whose accuracy depends on the choice of strikes in the portfolio of options over which the sum is taken.

One feature of replication based on European options is that European call and put options are relatively liquid derivatives and they tend to be the first payment functions that are priced in any model as that model is developed. Modeling choice can therefore be a matter of configuration—a declarative statement, kept separate from any specifics of the form of ƒ(x). Typically, replicating a payment function imposes a greater computational cost than obtaining an intrinsic value. However, replication provides a construct for handling the valuation of payment functions in circumstances where method 200 detects convexity and/or cannot detect the absence of convexity. Replication based on European put and call options may be sufficient for most valuation problems.

In some circumstances, a payment function to be replicated will comprise a function of more than one variable. Quantos are an example of this circumstance, depending on the underlying asset price and the FX rate. Equation (52) may be generalized to a two-dimensional function ƒ(x,y) which is twice differentiable in each argument to

$$f ( x , y ) = f ( x , {y}_{0} ) + f ( {x}_{0} , y ) - f ( {x}_{0} , {y}_{0} ) + {f}_{12} ( {x}_{0} , {y}_{0} ) ( x - {x}_{0} ) ( y - {y}_{0} ) + ( x - {x}_{0} ) ( {\int }_{y}^{{y}_{0}} {f}_{122} ( {x}_{0} , {k}_{2} ) {( {k}_{2} - y )}^{+} d {k}_{2} + {\int }_{{y}_{0}}^{y} {f}_{122} ( {x}_{0} , {k}_{2} ) {( y - {k}_{2} )}^{+} d {k}_{2} ) + ( y - {y}_{0} ) ( {\int }_{x}^{{x}_{0}} {f}_{112} ( {k}_{1} , {y}_{0} ) {( {k}_{1} - x )}^{+} d {k}_{1} + {\int }_{{x}_{0}}^{x} {f}_{112} ( {k}_{1} , {y}_{0} ) {( x - {k}_{1} )}^{+} d {k}_{1} ) + {\int }_{y}^{{y}_{0}} ( {\int }_{x}^{{x}_{0}} {f}_{1122} ( {k}_{1} , {k}_{2} ) {( {k}_{1} - x )}^{+} d {k}_{1} + {\int }_{{x}_{0}}^{x} {f}_{1122} ( {k}_{1} , {k}_{2} ) {( x - {k}_{1} )}^{+} d {k}_{1} ) {( {k}_{2} - y )}^{+} d {k}_{2} + {\int }_{{y}_{0}}^{y} ( {\int }_{x}^{{x}_{0}} {f}_{1122} ( {k}_{1} , {k}_{2} ) {( {k}_{1} - x )}^{+} d {k}_{1} + {\int }_{{x}_{0}}^{x} {f}_{1122} ( {k}_{1} , {k}_{2} ) {( x - {k}_{1} )}^{+} d {k}_{1} ) {( y - {k}_{2} )}^{+} d {k}_{2} \qquad ( 53 )$$

where numerical subscripts on the function ƒ(x y) indicate partial derivatives in the corresponding argument. For example,

$${{f}_{112} ( {k}_{1} , {k}_{2} ) = \frac{{\partial }^{3}}{\partial {x}^{2} \partial y} f ( x , y ) \vert}_{{k}_{1} , {k}_{2}} \qquad ( 59 )$$

Equation (53) already represents a moderately cumbersome expression and taking the risk-neutral expectation of both sides of equation (53) to determine the present value of ƒ(x,y) may be even more complex. As discussed above, one of the attractive aspects of equation (52) is the fact that by choosing linear segments as our basis for representing the function ƒ(x), we benefit from a relatively liquid market in European call and put options. The same is not true of the equivalent two-dimensional European option payoffs that form the basis for replicating the function ƒ(x,y), for example

(x−k₁)⁺(y−k₂)⁺ (60)

There may be no liquid market in such options. If there was, it would essentially be a market for the correlation between the two underlyings x and y. The marginal distribution of each underlying is constrained by each associated vanilla option market. The only missing ingredient for the joint distribution of both underlyings is their copula, which may be parametrized by a single correlation, or might have some other functional form. In practice, it may be difficult or otherwise impractical to calibrate correlation to market quotes. Instead, in some embodiments, correlation values may be chosen based on intuition. With an appropriate copula, however, we can price two-dimensional options like the example of equation (60). The marginal distribution for each underlying may be encoded in the respective vanilla option markets and given any marginals, the copula yields the joint distribution, over which equation (60) can be integrated to give the expected forward value.

It will be appreciated from the discussion above, that it is possible to generalize equation (53) to even higher numbers of dimensions, but that this may be somewhat impractical because of the exponentially increasing complexity of the expression together with the difficulties associated with pricing higher order options forming the basis for the expansion. However, not all multiple-variable payment functions contain significant interactions among the entire set of variables. In some embodiments and/or in some circumstances, the replication procedures used in method 100 may express some multiple-variable payment functions as sums of functions of disjoint subsets of the set of variables. For example, the function

ƒ(x,y,z)=sin(x)+\sqrt{z²−y²} (61)

divides the space {x,y,z} into the subspaces {x} and {y,z}. The expected value of ƒ(x,y,z) over the full, joint density p(x,y,z) can be written as the sum of two expectations, each over the relevant marginals,

$$\begin{matrix}𝔼 [ f ( x , y , z ) ] = \int f ( x , y , z ) p ( x , y , z ) d x d y d z \\ = \int sin ( x ) {p}_{x} ( x ) d x + \int \sqrt{{z}^{2} - {y}^{2}} {p}_{yz} ( y , z ) d y d z\end{matrix} \qquad ( 62 )$$

where the marginals pₓ(x) and p_{yz}(y,z) are given by

pₓ(x)=∫p(x,y,z)dydz (63)

and

p_{yz}(y,z)=∫p(x,y,z)dx (64)

Some embodiments comprise applying a systematic approach to the discovery of such decoupled subsets of the variable set ψ={xᵢ} where i=1 . . . N for an arbitrary function of N variables ƒ(x₁, x₂, . . . , xₙ), by writing it as a sum over functions of each element in the power set (the set of all subsets) of ψ, as follows. Let (N,n)ᵢ be the i^{th} n-subset ψ and define

I_{(N,n)}_{ᵢ}=∫ƒ(x₁,x₂, . . . ,x_{N})d^{m}^{ᵢ}x (65)

where mᵢ is the exclusive OR (XOR) of ψ with (N−n)ᵢ. In other words, integrate (marginalize) over the variables not included in the i^{th} n-subset of ψ. For example,

I_{xy}=∫ƒ(x,y,z)dz (66)

and

I₀=∫ƒ(x,y,z)dxdydz (67)

Then, we can write the function ƒ(x₁, x₂, . . . x_{N}) as

$$f ( {x}_{1} , {x}_{2} , … , {x}_{N} ) = {\sum }_{n = 0}^{N} {\sum }_{k = 1}^{( \begin{matrix}N \\ n\end{matrix} )} {μ}_{{( N , n )}_{k}} \qquad ( 68 )$$

Where each “interaction term” μ_{(N,n)}_{ᵢ} can be expressed in terms of the integrals I_{(N,n)}_{ᵢ} recursively via

$${μ}_{{( N , n )}_{i}} = {I}_{{( N , n )}_{i}} - {\sum }_{m = 0}^{n - 1} {\sum }_{j = 1}^{( \begin{matrix}n \\ m\end{matrix} )} {μ}_{{( n , m )}_{i}} \qquad ( 69 )$$

For example, a function of three variables ƒ(x,y,z) can be written as

ƒ(x,y,z)=μ_{xyz}+μ_{xy}+μ_{xz}+μ_{yz}+μₓ+μ_{y}+μ_{z}+μ₀ (70)

where

μ₀=I₀ (71)

μₓ=Iₓ−μ₀ (72)

μ_{y}=I_{y}−μ₀ (73)

μ_{z}=I_{z}−μ₀ (74)

μ_{xy}=I_{xy}−μₓ−μ_{y}−μ₀ (75)

μ_{xz}=I_{xz}−μₓ−μ_{z}−μ₀ (76)

μ_{yz}=I_{yz}−μ_{y}−μ_{z}−μ₀ (77)

μ_{xyz}=I_{xyz}−μ_{xy}−μ_{xz}−μ_{yz}−μₓ−μ_{y}−μ_{z}−μ₀ (78)

and where I_{xyz}=ƒ(x,y,z) by definition. In some embodiments, the degree of interaction among arbitrary subsets of the variable set may then be quantified using a suitable norm of the relevant interaction term. In the example of equation (62), we have μ_{xyz}, μ_{xy} and μ_{xz} all vanish but μ_{yz} does not.

For an arbitrary functional form, the integrals of equation (65) may be evaluated numerically which, for high-dimensional problems, may comprise a Monte Carlo simulation. At first impression, therefore, it may appear that there is little value in such a method, given that it is desirable for method 100 to reduce the computational expense and the corresponding complexity of Monte Carlo simulations. However, the simulations associated with examining the interaction terms of equation (69) do not require complex models—they are not expectations over a distribution (as is the case with payment functions of stochastic variables). The simulations associated with examining the interaction terms of equation (69) are simpler and just involve integrating over the functional form of the payment function. In addition, some embodiments may involve starting with low-dimensional integrals and restricting the exploration among small subsets (e.g. one, two or three variables) of the variable space, because the aim of the exploration is to identify decoupled subsets of variables to which one, two or three-dimensional replication may be applied. This is considerably cheaper (from a computational and complexity perspective) than a full model-based on a many-dimensional Monte Carlo simulation.

If the variables in a multi-dimensional payment function can be divided into independent subsets, then the expectation of the payment function divides accordingly, as we saw in the case of equation (62). In such a case, the relatively high dimensional replication problem is reduced to a set of smaller problems, each of which may be relatively more easily solvable (e.g. from the perspective of computational expense and complexity). Consider a payment function g(x,y) for which the numerical analysis described above reveals that the variables x and y each form independent subspaces,

g(x,y)=μₓ+μ_{y}+μ₀ (79)

Applying replication to each of μₓ and μ_{y} may be computationally expensive, because each is a function of integrals over the payment function g(x,y). Fortunately, however, the integrals in equation (52) only depend on the second derivative of μₓ and μ_{y}. Taking the first variable, we have

$${μ}_{x}^{″} = \frac{{\partial }^{2}}{\partial {x}^{2}} ( g ( x , y ) - {μ}_{y} - {μ}_{0} ) = \frac{{\partial }^{2} g ( x , y )}{\partial {x}^{2}} \qquad ( 80 )$$

Although it appears that there should be some y-dependence in the final term of equation (80), it does not matter what value of y we choose when performing the replication procedure for the x variable, and similarly for the y variable. In general, if a payment function can be written in the form of equation (79), then any x-derivative of g(x,y) will be independent of y and any y derivative will be independent of x. This means that, once independent subspaces have been established by the techniques described above, we may proceed with replication directly on the payment function and not its constituent interaction terms.

In the discussion above, we have described the theory of replication in one dimension and multiple dimensions and have presented some techniques for breaking higher-dimensional replication problems into collections of tractable replications for suitable payment functions. We now describe the practical task of approximating equation (52) with a finite collection of European call and put options. It will be appreciated from the discussion that follows that replication based on option pricing represents a form of linear interpolation. This knowledge may be used to detect potential absence of convexity of a payment function in addition to or in the alternative to using the replication procedure to valuate the payment function. In particular embodiments, replications manifest as a collection of weights, each multiplying an option payment function of a given strike. A number of suitable algorithms may be used to determine suitable weights and/or strikes. First, we describe a simple algorithm that makes clear the link between replication and linear interpolation.

A method for finding weights for a known collection of strikes {kᵢ} for i=0 . . . n comprises defining the replication as

$$\tilde{f} ( x ) ≡ f ( {k}_{0} ) + {\sum }_{i = 0}^{n} {( x - {k}_{i} )}^{+} {w}_{i} \qquad ( 81 )$$

for weights {wᵢ, over the domain x>k₀. In this domain, the “positive part” operation for the first term in the sum is redundant, and we identify the first term in the sum, with weight W₀, with the gradient of a straight line through the point (k₀,ƒ(k₀)). Imposing the constraint that \tilde{ƒ}(x) match ƒ(x) exactly at each kᵢ leads to

$${w}_{0} = \frac{f ( {k}_{1} ) - f ( {k}_{0} )}{{δ}_{0}} \\ {w}_{1} = \frac{f ( {k}_{2} ) - f ( {k}_{1} )}{{δ}_{1}} - {w}_{o} \\ … \\ {w}_{n} = \frac{f ( {k}_{n + 1} ) - f ( {k}_{ n} )}{{δ}_{n}} - {\sum }_{i = 0}^{n - 1} {w}_{i} \qquad ( 82 )$$

where δᵢ=kᵢ₊₁−kᵢ. If instead we had imposed the constraint that that \tilde{ƒ}(x) match ƒ(x) exactly at the midpoint of each interval between kᵢ and kᵢ₊₁, we would obtain different, but very similar, formulae. The constraint we choose to obtain (82) may comprise that which maps most cleanly onto linear interpolation. For the i^{th} interval between kᵢ and kᵢ₊₁,
linear interpolation gives the function

$$\begin{matrix}{f}_{L} ( x ) ≡ f ( {k}_{i} ) + {γ}_{i} ( x - {x}_{i} ) \\ where & ( 83 ) \\ {γ}_{i} = \frac{f ( {k}_{i + 1} ) - f ( {k}_{i} )}{{δ}_{i}} & ( 84 )\end{matrix}$$

Comparison with equation (82) shows that for i>0

wᵢ=γᵢ−γᵢ₋₁ (85)

and for i=0, γ₀=w₀, consistent with the weights representing the curvature of the function ƒ(x). This is the first phase of pricing a twice differentiable, but otherwise arbitrary, payment function. The second phase is equivalent to taking the risk-neutral expectation of each side of equation (81), turning the i^{th} term in the sum into a call option struck at kᵢ.

Equation (85) shows that there is no fundamental difference between the first phase of replication and linear interpolation, which means we may bring to bear the full arsenal of techniques in this field to find a suitable set of strikes and weights for the replicating European option portfolio. In some embodiments, the linear interpolation method may find, for a linear payment function, that there is only one term present, with weight w₀=γ₀, the gradient of the line. In this manner, some embodiments are capable of numerically detecting the absence of convexity which has otherwise gone undetected through method 200.

An interesting optional feature which may be used in some embodiments comprises querying the components of the function ƒ(x) itself for an option replicating portfolio, then propagating this portfolio through the function. This approach is particularly effective when ƒ(x) itself comprises one or more option payoffs, in which case certain strikes may be identified as special, and therefore should be present in the replicating portfolio. The limiting case would be a payment function consisting of a single European option

ƒ_{*}(x)=(x−k_{*})⁺ (86)

In this case, the value-matching algorithm of equation (81) would give non-zero weights in the two strikes immediately bracketing k*, which may introduce unnecessary complexity into the valuation. This complexity could be avoided in the relevant cases if functional forms appearing in the expressions of payment functions could supply their own recommendations for replicating portfolios. In the case of ƒ*(x), the associated replication would have just one term (a single option). In the case of a call spread, as might be constructed as an approximation for a digital option payoff, the associated replication may have two terms whose strikes are close together. For a linear function, there may be no strikes present in the replication, just a single weight for the gradient term in equation (52)) (the first (i=0) term in the sum in equation (82)).

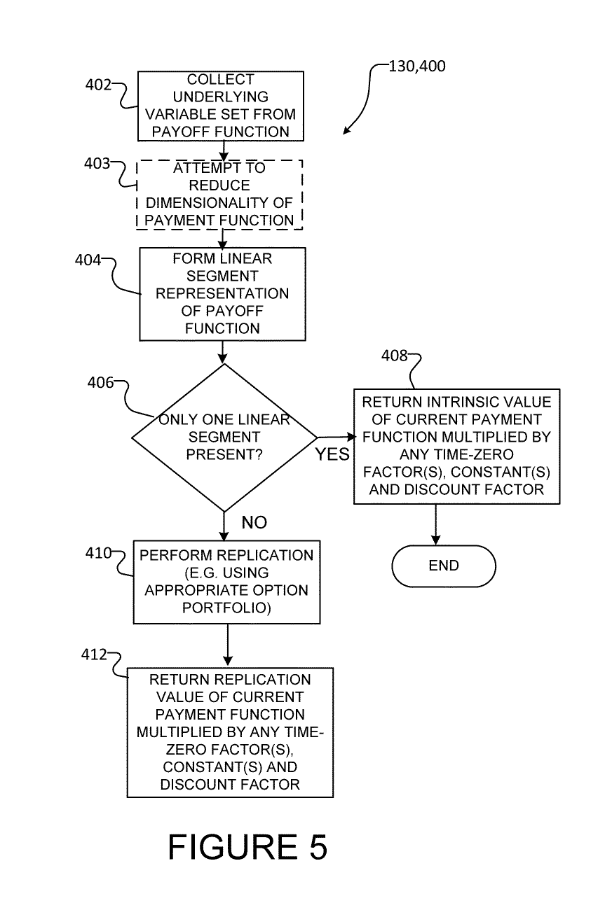

FIG. 5 is a schematic depiction of a method 400 which may be used to implement block 130 in some embodiments. Method 400 comprises the use of replication methodologies. Method 400 commences in block 402 which comprises identifying the stochastic variables (underlyings) remaining in the current payment function, after it might had been modified by the various measure changes in blocks 110 and/or 120. Method 400 then proceeds to optional block 403 which comprises an attempt to reduce the complexity of the replication problem (e.g. by reducing the dimensionality of the replication problem). As discussed above, the computational complexity of replication techniques scales exponentially with the number of stochastic variables in the payment function being replicated. Consequently, it can be desirable (as also discussed above) to minimize or reduce the number of stochastic variables being considered during a replication procedure. In some cases, for example where a multidimensional payment function may be reduced (in optional block 403) to a sum of lower-dimensional functions, it may still be possible to proceed via one or two-dimensional replication when the number of variables is higher. This block 403 reduction in the number of stochastic variables being considered for replication need not necessarily be exact, but could be subject to a numerical tolerance. For example, it may be that there is non-zero dependence among several variables in the payment function, yet block 403 may make the judgment to neglect that dependence for the purposes of valuation by replication.

Method 400 then proceeds to block 404 which comprises generating a linear segment representation of the current payment function, where here we use a generalized interpretation of the phrase “linear segment” which may be extended to rectangular surfaces (in two dimensions) and cuboids (in three dimensions). The block 404 linear segment representation may be performed using any of many suitable numerical techniques for generating a piecewise linear segment representation of the current payment functions. Such techniques, may include, by way of non-limiting example, linear interpolation, adaptive linear interpolation and/or the like. In one particular embodiment for a one-dimensional replication (i.e. a payment function with a single stochastic variable), the current payment function may be modelled as a sum of weighted European call and put option payoff functions. The parameters of such a linear segment representation include a set of one or more weights {wᵢ} and strikes {kᵢ} of the corresponding options. For higher order replications, the block 404 linear segment representation may be constructed in accordance with the replication techniques described above.

Once the block 404 linear segmentation is determined, method 400 proceeds to block 406 which comprises evaluating whether the block 404 linear segment representation only includes a single linear segment. If it is determined in block 406 that the block 404 linear segment representation only includes a single linear segment (or, in some embodiments, if it is determined in block 406 that the segments of the block 404 linear segment representation are within a suitable threshold of being a single linear segment), then it may be concluded that the current payment function is in fact linear. When this conclusion is made (block 406 YES branch), method 400 proceeds to block 408 which involves determining the intrinsic value of the current payment function and multiplying this intrinsic value by any time-zero factors to output the method 100 valuation 132 of the input payment function 102 (see FIG. 1). Block 408 may be substantially similar to block 258 (FIG. 3B) discussed above.

If the block 406 inquiry is negative (block 406 NO branch), then method 400 proceeds to block 410. Block 410 comprises performing a replication procedure. In some embodiments, the block 410 replication procedure may comprise using option pricing. Option pricing may comprise using a suitable portfolio of European call and put options and their corresponding weights {wᵢ} and strikes {kᵢ} to replicate the current payment function and then valuating the portfolio of options to arrive at an approximate expectation of the current payment function.

Method 400 then proceed to block 412 which involves multiplying the result of the block 410 replication valuation by any time-zero factors created by the above-discussed measure modification procedures and returning the result as valuation 132 of input payment function 102 resulting from method 100 (see FIG. 1).

We consider the Example I European option which comprises a valuation of

V_{call}(0)=NαP(0,t) [symbol] ^{t}[max(S(s)−k,0)] (133)

The initial measure is the payment time (t) forward measure which is also the natural measure of the underlying S(s). There may be no discernable numeraire-transform factors. Consequently, the Example I payment function ends up in block 130 (method 400). The payment function of equation (133) is non-linear and so the block 404 linear segment representation contains multiple (2 in this case) segments and the block 406 inquiry is negative. Consequently, method 400 proceeds to replication. Since there is only one option in Example I, the replication of the Example I payment function in block 410 may determine a single weight of unity and a single strike of k.

We also consider the Example H put-call parity whose valuation is

V_{call}(0)=NαP(0,t) [symbol] ^{t}[max(S(s)−k,0)−max(k−S(s),0)] (134)

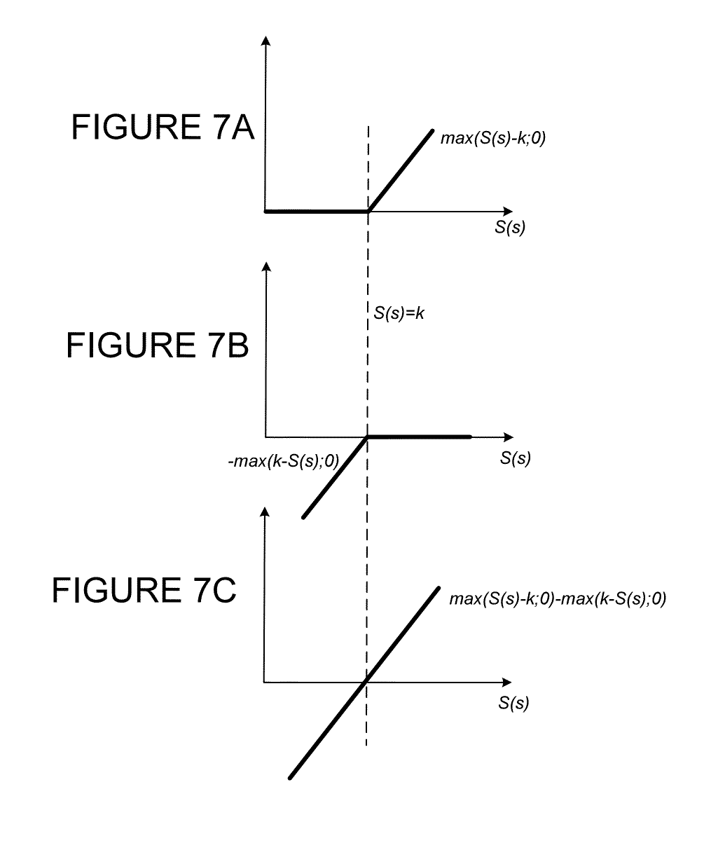

Example H is similar to Example I, except that its block 404 linear segment representation contains only one segment and so the block 406 inquiry is positive. In particular, the expression max(S(s)−k; 0) looks like that shown in FIG. 7A, the expression −max(k−S(s); 0) looks like that shown in FIG. 7B and their sum looks like the line shown in FIG. 7C. Consequently, the Example H payment function expressed in equation (134) may be intrinsically valuated in block 408.

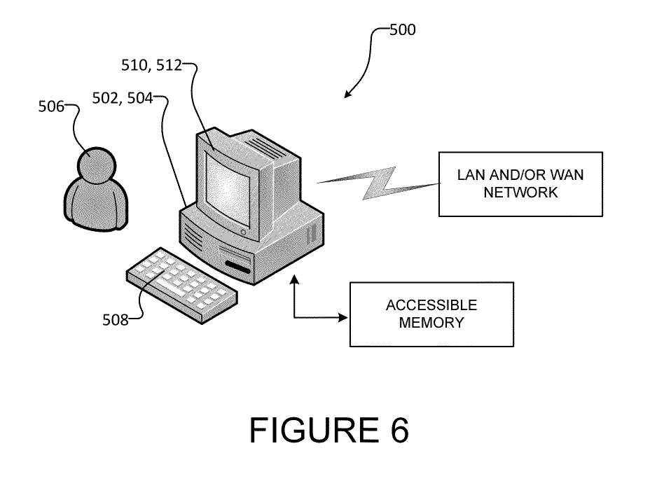

FIG. 6 is a schematic depiction of a system 500 which may be used to perform any of the methods described herein and the steps of any of the methods described herein according to a particular embodiment. System 500 of the illustrated embodiment comprises a computer 502 which may comprise one or more processors 504 which may in turn execute suitable software 505. When such software 505 is executed by computer 502 (and in particular processor(s) 504), computer 502 and/or processor(s) 504 may perform any of the methods described herein and the steps of any of the methods described herein. In the illustrated embodiment, computer 502 provides a user interface 510 for interaction with a user 506. From a hardware perspective, user interface 510 comprises one or more input devices 508 by which user 506 can input information to computer 502 and one or more output devices 512 by which information can be output to user 506. In general, input devices 508 and output devices 512 are not limited to those shown in the illustrated embodiment of FIG. 6. In general, input device 508 and output device 512 may comprise any suitable input and/or output devices suitable for interacting with computer 502. User interface 510 may also be provided in part by software 505 when such software is executed by computer 502 and/or its processor(s) 504. In the illustrated embodiment, computer 502 is also connected to access data (and/or to store data) on accessible memory device 518. In the illustrated embodiment, computer 502 is also connected by communication interface 514 to a LAN and/or WAN network 516, to enable accessing data from networked devices (not shown) and/or communication of data to networked devices.

Input payment function 102 (FIG. 1) may be obtained by computer 502 via any of its input mechanisms, including, without limitation, by any input device 508, from accessible memory 518, from network 516 or by any other suitable input mechanism. The outputs 132, 134 of method 100 may be output from computer 502 via any of its output mechanisms, including, without limitation, by any output device 512, to accessible memory 518, to network 516 or to any other suitable output mechanism. As discussed above, the FIG. 6 is merely a schematic depiction of a particular embodiment of a computer-based system 500 suitable for implementing the methods described herein. Suitable systems are not limited to the particular type shown in the schematic depiction of FIG. 6 and suitable components (e.g. input and output devices) are not limited to those shown in the schematic depiction of FIG. 6.

The methods described herein may be implemented by computers comprising one or more processors and/or by one or more suitable processors, which may, in some embodiments, comprise components of suitable computer systems. By way of non-limiting example, such processors could comprise part of a computer-based automated contract valuation system. In general, such processors may comprise any suitable processor, such as, for example, a suitably configured computer, microprocessor, microcontroller, digital signal processor, field-programmable gate array (FPGA), other type of programmable logic device, pluralities of the foregoing, combinations of the foregoing, and/or the like. Such a processor may have access to software which may be stored in computer-readable memory accessible to the processor and/or in computer-readable memory that is integral to the processor. The processor may be configured to read and execute such software instructions and, when executed by the processor, such software may cause the processor to implement some of the functionalities described herein.

Certain implementations of the invention comprise computer processors which execute software instructions which cause the processors to perform a method of the invention. For example, one or more processors in a computer system may implement data processing steps in the methods described herein by executing software instructions retrieved from a program memory accessible to the processors. The invention may also be provided in the form of a program product. The program product may comprise any medium which carries a set of computer-readable signals comprising instructions which, when executed by a data processor, cause the data processor to execute a method of the invention. Program products according to the invention may be in any of a wide variety of forms. The program product may comprise, for example, physical (non-transitory) media such as magnetic data storage media including floppy diskettes, hard disk drives, optical data storage media including CD ROMs, DVDs, electronic data storage media including ROMs, flash RAM, or the like. The instructions may be present on the program product in encrypted and/or compressed formats.

Where a component (e.g. a software module, controller, processor, assembly, device, component, circuit, etc.) is referred to above, unless otherwise indicated, reference to that component (including a reference to a “means”) should be interpreted as including as equivalents of that component any component which performs the function of the described component (i.e., that is functionally equivalent), including components which are not structurally equivalent to the disclosed structure which performs the function in the illustrated exemplary embodiments of the invention.

While a number of exemplary aspects and embodiments are discussed herein, those of skill in the art will recognize certain modifications, permutations, additions and sub-combinations thereof. For example:
In the embodiments discussed above, method 300 of FIG. 4 comprises determining a numeraire-injection factor and then ascertaining if there are modeling assumptions that could be substituted into the determined numeraire-injection factor to express the determined numeraire-transform factor in terms of the variables of the current payment function. In some embodiments, this search for and substitution of modeling assumptions could additionally or alternatively be performed in “reverse”, where modelling assumptions may be substituted into the current payment function to express the current payment function in terms of variables that are present in the determined numeraire-transform factor. It will be appreciated that such modeling assumption based substitutions could additionally or alternatively be used to reduce the dimensionality of the overall payment function after injection of the numeraire-transform factor.
In some embodiments, modelling assumptions could be used even where there are no injected numeraire-transform factors. Such modelling assumptions could be substituted into the payment function in effort to reduce the dimensionality of the payment function prior to replication, for example.

While a number of exemplary aspects and embodiments have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as are within their true spirit and scope.

What is claimed is:

1. A method for addressing convexity in automated valuation of financial contracts, the method performed by a processor programmed to perform the steps of the method and comprising:
receiving, by the processor, an input payment function;
setting, by the processor, a current payment function based on the input payment function, the current payment function associated with a current measure;
determining, by the processor, a non-convexity status based on the current payment function, the non-convexity status comprising at least one of:
a confirmation indication, the confirmation indication corresponding to a confirmation of non-convexity; and
a failure indication, the failure indication corresponding to a failure to confirm non-convexity of the input payment function;
if the non-convexity status comprises a confirmation indication, determining, by the processor, an output valuation of the input payment function based at least in part on an intrinsic value, the intrinsic value based on the current payment function and the current measure;
if the non-convexity status comprises a failure indication, determining, by the processor, that the intrinsic value is not suitable as a valuation for the input payment function.

2. A method according to claim 1 wherein determining the non-convexity status comprises checking for an absence of convexity based on the current payment function and checking for an absence of convexity comprises:
determining, by the processor, whether the current payment function comprises one or more stochastic variables;
if the current payment function comprises no stochastic variables, determining, by the processor, that the non-convexity status comprises the confirmation indication; and
if the current payment function comprises one or more stochastic variables:
determining, by the processor, whether the one or more stochastic variables satisfy one or more linearity criteria; and
if the one or more stochastic variables satisfy the one or more linearity criteria, determining, by the processor, that the non-convexity status comprises the confirmation indication.

3. A method according to claim 2 wherein determining whether the one or more stochastic variables satisfy one or more linearity criteria comprises determining whether a unique natural measure exists for all of the one or more stochastic variables.

4. A method according to claim 3 wherein determining whether the one or more stochastic variables satisfy one or more linearity criteria comprises determining whether the unique natural measure is the same as the current measure associated with the current payment function.

5. A method according to claim 4 wherein determining whether the one or more stochastic variables satisfy one or more linearity criteria comprises analyzing, by the processor, the current payment function and determining, by the processor, whether the current payment function may be expressed in a linear functional form.

6. A method according to claim 5 wherein analyzing the current payment function comprises performing, by the processor, symbolic algebraic analysis based on the current payment function.

7. A method according to claim 2 comprising, if checking for an absence of convexity does not result in determining that the non-convexity status comprises the confirmation indication:
transforming, by the processor, the current payment function based on a numeraire-transform factor; and
changing, by the processor, the current measure based on a measure associated with the numeraire-transform factor.

8. A method according to claim 7 wherein transforming the current payment function comprises:
determining, by the processor, whether the numeraire-transform factor is present, as a factor, in the current payment function;
if the numeraire-transform factor is determined to be present in the current payment function, eliminating, by the processor, the numeraire-transform factor from the current payment function by factoring the numeraire-transform factor out from the current payment function.

9. A method according to claim 8 wherein determining whether the numeraire-transform factor is present in the current payment function comprises:
determining, by the processor, whether a modelling assumption is available for substitution into the current payment function; and
if the modelling assumption is available for substitution into the current payment function, substituting, by the processor, the modelling assumption into the current payment function.

10. A method according to claim 9 comprising:
if the modelling assumption is not available for substitution into the current payment function, providing, by the processor, a request for a new modelling assumption to a user; and
in response to receiving a new modelling assumption from the user, substituting, by the processor, the new modelling assumption into the current payment function.

11. A method according to claim 7 wherein the output valuation is based at least in part on the intrinsic value and on a time-zero factor, the time-zero factor based on the numeraire-transform factor.

12. A method according to claim 7 comprising iteratively transforming the current payment function based on each of a plurality of numeraire-transform factors until no numeraire-transform factor is detectable in the current payment function.

13. A method according to claim 12 comprising, after each transformation of the current payment function, checking, by the processor, for an absence of convexity based on the transformed current payment function.

14. A method according to claim 12 comprising, in response to determining that no numeraire-transform factor is detectable in the current payment function, checking, by the processor, for an absence of convexity based on the current payment function.

15. A method according to claim 7 comprising:
determining, by the processor, whether a unique natural measure exists for all of the one or more stochastic variables associated with the current payment function;
if the unique natural measure does exist, changing, by the processor, the current measure associated with the current payment function to match the unique natural measure.

16. A method according to claim 15 comprising, if the unique natural measure does not exist:
determining, by the processor, whether a replication measure associated with a replication model may be applied against a plurality of stochastic variables associated with the current payment function;
if the replication measure does exist, changing, by the processor, the current measure to match the replication measure.

17. A method according to claim 16 comprising, if the replication measure does not exist, determining, by the processor, that the non-convexity status comprises a failure indication.

18. A method according to claim 16 wherein the replication model comprises an option-pricing model and the replication measure comprises an option-pricing measure.

19. A method according to claim 18 wherein the option-pricing model comprises a model based on European call and put options.

20. A method according to claim 15 wherein changing the current measure to match the unique natural measure comprises:
determining, by the processor, whether the current measure matches the unique natural measure;
if the current measure does not match the unique natural measure:
determining, by the processor, an injection numeraire-transform factor, which would, if injected into the current payment function, change the current measure to match the unique natural measure;
transforming, by the processor, the current payment function by injecting the injection numeraire-transform factor into the current payment function and thereby changing, by the processor, the current measure to match the unique natural measure.

21. A method according to claim 20 comprising:
determining, by the processor, whether a numeraire modelling assumption is available for substitution into the injection numeraire-transform factor; and
if the numeraire modelling assumption is available for substitution into the injection numeraire-transform factor, substituting, by the processor, the numeraire modelling assumption into the injection numeraire-transform factor.

22. A method according to claim 21 wherein substituting, by the processor, the numeraire modelling assumption into the injection numeraire-transform factor reduces the dimensionality of the current payment function.

23. A method according to claim 21 wherein the numeraire modelling assumption expresses the numeraire-transform factor in terms of stochastic variables already present in the current payment function.

24. A method according to claim 16 wherein determining whether the replication measure associated with the replication model may be applied against the plurality of stochastic variables comprises:
generating, by the processor, a linear segment representation of the current payment function;
determining, by the processor, whether only one linear segment is present in the linear segment representation;
if only one linear segment is present in the linear segment representation, determining, by the processor, that the non-convexity status comprises the confirmation indication; and
if a plurality of linear segments are present in the linear segment representation:
performing, by the processor, a replication procedure based on the replication model; and
determining, by the processor, the output valuation based on the replication procedure.

25. A method according to claim 1 comprising setting, by the processor, an initial value for the current measure to a t-forward measure for payment at a time t.

26. A system for addressing convexity in automated valuation of financial contracts, the system comprising a processor configured to:
receive an input payment function;
set a current payment function based on the input payment function, the current payment function associated with a current measure;
determine a non-convexity status based on the current payment function, the non-convexity status comprising at least one of:
a confirmation indication, the confirmation indication corresponding to a confirmation of non-convexity; and
a failure indication, the failure indication corresponding to a failure to confirm non-convexity of the input payment function;
if the non-convexity status comprises a confirmation indication, determine an output valuation of the input payment function comprising an intrinsic value based at least in part on the current payment function and the current measure;
if the non-convexity status comprises a failure indication, determine that the intrinsic value is not suitable as a valuation for the input payment function.

27. A system according to claim 26 wherein the processor being configured to determine the non-convexity status comprises the processor being configured to check for an absence of convexity based on the current payment function, and the processor being configured to check for an absence of convexity comprises the processor being configured to:
determine whether the current payment function comprises one or more stochastic variables;
if the current payment function comprises no stochastic variables, determine that the non-convexity status comprises the confirmation indication; and
if the current payment function comprises one or more stochastic variables:
determine whether the one or more stochastic variables satisfy one or more linearity criteria; and
if the one or more stochastic variables satisfy the one or more linearity criteria, determine that the non-convexity status comprises the confirmation indication.

28. A system according to claim 27 wherein the processor being configured to determine whether the one or more stochastic variables satisfy one or more linearity criteria comprises the processor being configured to determine whether a unique natural measure exists for all of the one or more stochastic variables.

29. A system according to claim 28 wherein the processor being configured to determine whether the one or more stochastic variables satisfy one or more linearity criteria comprises the processor being configured to determine whether the unique natural measure is the same as the current measure associated with the current payment function.

30. A system according to claim 29 wherein the processor being configured to determine whether the one or more stochastic variables satisfy one or more linearity criteria comprises the processor being configured to analyze the current payment function and determine whether the current payment function may be expressed in a linear functional form.

31. A system according to claim 30 wherein the processor being configured to analyze the current payment function comprises the processor being configured to perform symbolic algebraic analysis based on the current payment function.

32. A system according to claim 27 wherein the processor is configured to, if checking for an absence of convexity does not result in the determining that the non-convexity status comprises the confirmation indication:
transform the current payment function based on a numeraire-transform factor; and
change the current measure based on a measure associated with the numeraire-transform factor.

33. A system according to claim 32 wherein the processor being configured to transform the current payment function comprises the processor being configured to:
determine whether the numeraire-transform factor is present, as a factor, in the current payment function;
if the numeraire-transform factor is determined to be present in the current payment function, eliminate the numeraire-transform factor from the current payment function by factoring the numeraire-transform factor out from the current payment function.

34. A system according to claim 33 wherein the processor being configured to determine whether the numeraire-transform factor is present in the current payment function comprises the processor being configured to:
determine whether a modelling assumption is available for substitution into the current payment function; and
if the modelling assumption is available for substitution into the current payment function, substitute the modelling assumption into the current payment function.

35. A system according to claim 34 wherein the processor is configured to:
if the modelling assumption is not available for substitution into the current payment function, provide a request for a new modelling assumption to a user; and
in response to receiving a new modelling assumption from the user, substitute the new modelling assumption into the current payment function.

36. A system according to claim 32 wherein the processor is configured to base the output valuation at least in part on the intrinsic value and on a time-zero factor, the time-zero factor based on the numeraire-transform factor.

37. A system according to claim 32 wherein the processor is configured to iteratively transform the current payment function based on each of a plurality of numeraire-transform factors until no numeraire-transform factor is detectable in the current payment function.

38. A system according to claim 37 wherein the processor is configured to, after each transformation of the current payment function, check for an absence of convexity based on the transformed current payment function.

39. A system according to claim 37 wherein the processor is configured to, in response to the processor being configured to determine that no numeraire-transform factor is detectable in the current payment function, check for an absence of convexity based on the current payment function.

40. A system according to claim 32 wherein the processor is configured to:
determine whether a unique natural measure exists for all of the one or more stochastic variables associated with the current payment function;
if the unique natural measure does exist, change the current measure associated with the current payment function to match the unique natural measure.

41. A system according to claim 40 wherein the processor is configured to, if the unique natural measure does not exist:
determine whether a replication measure associated with a replication model may be applied against a plurality of stochastic variables associated with the current payment function;
if the replication measure does exist, change the current measure to match the replication measure.

42. A system according to claim 41 wherein the processor is configured to, if the replication measure does not exist, determine that the non-convexity status comprises a failure indication.

43. A system according to claim 41 wherein the replication model comprises an option-pricing model and the replication measure comprises an option-pricing measure.

44. A system according to claim 43 wherein the option-pricing model comprises a model based on European call and put options.

45. A system according to claim 40 wherein the processor being configured to change the current measure to match the unique natural measure comprises the processor being configured to:
determine whether the current measure matches the unique natural measure;
if the current measure does not match the unique natural measure:
determine an injection numeraire-transform factor, which would, if injected into the current payment function, change the current measure to match the unique natural measure;
transform the current payment function by injecting the injection numeraire-transform factor into the current payment function and thereby change the current measure to match the unique natural measure.

46. A system according to claim 45 wherein the processor is configured to:
determine whether a numeraire modelling assumption is available for substitution into the injection numeraire-transform factor; and
if the numeraire modelling assumption is available for substitution into the injection numeraire-transform factor, substitute the numeraire modelling assumption into the injection numeraire-transform factor.

47. A system according to claim 46 wherein substituting the numeraire modelling assumption into the injection numeraire-transform factor reduces the dimensionality of the current payment function

48. A system according to claim 46 wherein the numeraire modelling assumption expresses the numeraire-transform factor in terms of stochastic variables already present in the current payment function.

49. A system according to claim 41 wherein the processor being configured to determine whether the replication measure associated with the replication model may be applied against the plurality of stochastic variables comprises the processor being configured to:
generate a linear segment representation of the current payment function;
determine whether only one linear segment is present in the linear segment representation;
if only one linear segment is present in the linear segment representation, determine that the non-convexity status comprises the confirmation indication; and
if a plurality of linear segments are present in the linear segment representation:
perform a replication procedure based on the replication model; and
determine the output valuation based on the replication procedure.

50. A system according to claim 26 wherein the processor is configured to set an initial value for the current measure to a t-forward measure for payment at a time t.

51. A computer program product comprising non-transitory instructions which, when executed by a suitably configured processor, cause the processor to perform the method of claim 1.
